(19) United States
(12) Patent Application Publication
(10) Pub. No.: US 2017/0315358 A1
(43) Pub. Date: Nov. 2, 2017

(54) LIGHT GUIDE AND VIRTUAL IMAGE DISPLAY DEVICE

(71) Applicant: SHARP KABUSHIKI KAISHA, Sakai City, Osaka (JP)

(72) Inventor: Takeshi MASUDA, Sakai City, Osaka (JP)

(73) Assignee: SHARP KABUSHIKI KAISHA, Sakai City, Osaka (JP)

(21) Appl. No.: 15/507,870

(22) PCT Filed: Aug. 10, 2015
(86) PCT No.: PCT/JP2015/072654

§ 371 Date: Mar. 1, 2017

(30) Foreign Application Priority Data
Sep. 1, 2014 (JP) 2014-177472

(51) Int. Cl. G02B 27/01; F21V 8/00

(52) U.S. Cl. CPC G02B 27/0172; G02B 6/0036; G02B 6/002; G02B 2027/0125; G02B 2027/0118

(57) ABSTRACT

A lightguide includes: a coupling structure (32) having a light receiving surface receiving light from a display element (10); and a light guide plate (30) having a light receiving section at which light from the coupling structure enters, the light guide plate (30) including a plurality of reflecting sections (34A) arranged so as to reflect light entering from the light receiving section (30B) and traveling through an inside of the light guide plate mainly in a first direction, the light guide plate being configured such that the light reflected by the plurality of reflecting sections outgoes from an exit surface, wherein each of the plurality of reflecting sections has a reflecting surface which is oblique to the exit surface, and when seen in a normal direction of the exit surface, the area ratio per unit area of the oblique reflecting surface varies depending on a distance from the light receiving section.

### TECHNICAL FIELD

The present invention relates to a lightguide and a virtual image display device which includes the lightguide.

### BACKGROUND ART

In recent years, development of virtual image display devices for enlarging and displaying images formed by a small-size display element as virtual images, in the form of head mount displays and head up displays, has been promoted. The virtual image display devices are configured to project light emitted from a display element toward an eye of a viewer using a light guide plate or combiner. See-through type virtual image display devices are also capable of displaying a virtual image of an image formed by the display element so as to be superimposed on an external scene which is viewable through the light guide plate or combiner. Using such a virtual image display device enables to easily provide an AR (augmented reality) environment.

Patent Document 1 discloses a see-through type virtual image display device which is capable of displaying a virtual image so as to be superimposed on an external scene. This virtual image display device includes an image optical system including a display element and an optical guide element. Light from the display element is collimated before entering the optical guide element via a coupling section provided at an end portion of the optical guide element. The collimated light entering from the coupling section travels through the inside of the optical guide element and is then reflected by a diffraction grating for extraction of images before outgoing from a light exit surface of the optical guide element. A viewer can view a virtual image behind the light exit surface through the light exit surface. Note that, in Patent Document 1, the diffraction grating for extraction of images, which is provided in the optical guide element, has such a configuration that for example a semi-reflective film is provided on slopes of an uneven structure which has a sawtooth cross-sectional shape.

Patent Document 2 discloses a virtual image display device in which light from a display element is forced to enter a light guide plate via a prism, and this light is reflected by a reflecting array provided in the light guide plate. The prism is provided near an end portion of the light guide plate such that the light travels through the inside of the light guide plate toward the other end portion. The reflecting array used consists of a plurality of wedge-like recessed structures. More specifically, the reflecting array is configured to have a reflecting surface which is oblique to a light exit surface of the light guide plate, a parallel surface which is parallel to the light exit surface, and another oblique surface extending between the reflecting surface and the parallel surface.

### CITATION LIST

### Patent Literature

[Patent Document 1] Japanese Laid-Open Patent Publication No. 2004-157520

[Patent Document 2] U.S. Pat. No. 8,665,178

### SUMMARY OF INVENTION

### Technical Problem

However, according to research by the present inventor, it was found that, in the case of a conventional virtual image display device, there is a probability that the brightness of a virtual image to be viewed varies depending on the in-plane position on the light exit surface of the light guide plate, and there is a probability that the quality of the displayed image deteriorates due to unevenness in brightness. It was also found that, in the conventional virtual image display device, there is a probability that the brightness of an external scene viewed through the light guide plate or combiner does not appear uniform.

The present invention was conceived in view of the above problems. One of the major objects of the present invention is to provide a lightguide which is capable of suppressing unevenness in brightness of a virtual image to be viewed. Another object of the present invention is to provide a virtual image display device which includes such a lightguide.

### Solution to Problem

A lightguide of an embodiment of the present invention includes: a coupling structure having a light receiving surface receiving light from a display element; and a light guide plate having a light receiving section at which light from the coupling structure enters, the light guide plate including a plurality of reflecting structures arranged so as to reflect light entering from the light receiving section and traveling through an inside of the light guide plate mainly in a first direction, the light guide plate being configured such that the light reflected by the plurality of reflecting structures outgoes from an exit surface, wherein each of the plurality of reflecting structures has a reflecting surface which is oblique to the exit surface, and when seen in a normal direction of the exit surface, the area ratio per unit area of the oblique reflecting surface in the first direction varies depending on a distance from the light receiving section.

In one embodiment, the area ratio of the oblique reflecting surface in a region where the distance from the light receiving section is smaller is smaller than the area ratio of the oblique reflecting surface in a region where the distance from the light receiving section is greater.

In one embodiment, c(cos(γ)+sin(γ)tan(2α))≧2t·tan(2α) is met where α is the angle between the reflecting surface and the exit surface, γ is the angle between the light receiving surface of the coupling structure and the exit surface, c is a width of the light receiving surface of the coupling structure which is defined in a direction perpendicular to the intersection of the light receiving surface and the exit surface, and t is the thickness of the light guide plate.

In one embodiment, each of the plurality of reflecting structures has a prism structure, the reflecting surface is provided at one face of the prism structure, and when seen in a normal direction of the exit surface, a presence ratio per unit area of the prism structure increases as the distance from the light receiving section increases along the first direction.

In one embodiment, in an array of the plurality of prism structures included in the plurality of reflecting structures, a parallel surface which is generally parallel to the exit surface is provided between adjoining prism structures, a width of the parallel surface is greater at a first position that is closer to the light receiving section and is smaller at a second position that is more distant from the light receiving section.

In one embodiment, at a third position that is more distant from the light receiving section than the second position is, the parallel surface is not provided between the prism structures, and adjoining prism structures are in contact with each other.

In one embodiment, the parallel surface also has a reflecting surface.

In one embodiment, the lightguide further includes a planarizing layer, the planarizing layer being in contact with the plurality of prism structures, the planarizing layer being arranged so as to cover the plurality of prism structures, and the planarizing layer having a substantially flat surface.

In one embodiment, the plurality of prism structures are formed of a first transparent material by a 2p process, and the planarizing layer is also formed of the first transparent material.

In one embodiment, outside a region in which a prism structure having the reflecting surface is provided, a prism structure having no reflecting surface is provided.

In one embodiment, outside a region in which a prism structure having the reflecting surface is provided, a supporting structure which has the same height as the prism structure is provided.

In one embodiment, the reflecting surface is a semi-reflective surface which is configured to reflect part of light traveling through the inside of the light guide and transmit another part of the light.

A virtual image display device of an embodiment of the present invention includes any of the above-described lightguides and the display element, wherein the coupling structure of the lightguide is configured to receive virtual image projecting light from the display element.

In one embodiment, c(cos(γ)+sin(γ)tan(2α−θo′))≧2t·tan(2α+θo′) is met where α is the angle between the reflecting surface and the exit surface, γ is the angle between the light receiving surface of the coupling structure and the exit surface, c is a width of the light receiving surface of the coupling structure which is defined in a direction perpendicular to the intersection of the light receiving surface and the exit surface, t is the thickness of the light guide plate, ±θo is the angle of view in the first direction of the virtual image projecting light outgoing from the exit surface, and θo′ is the refraction angle at the light guide plate of light outgoing at the angle of view ±θo.

### Advantageous Effects of Invention

According to an embodiment of the present invention, a lightguide is provided which is capable of suppressing unevenness in brightness of a virtual image and a scene viewed through a light guide plate. According to another embodiment of the present invention, a virtual image display device is provided which is constructed using such a lightguide.

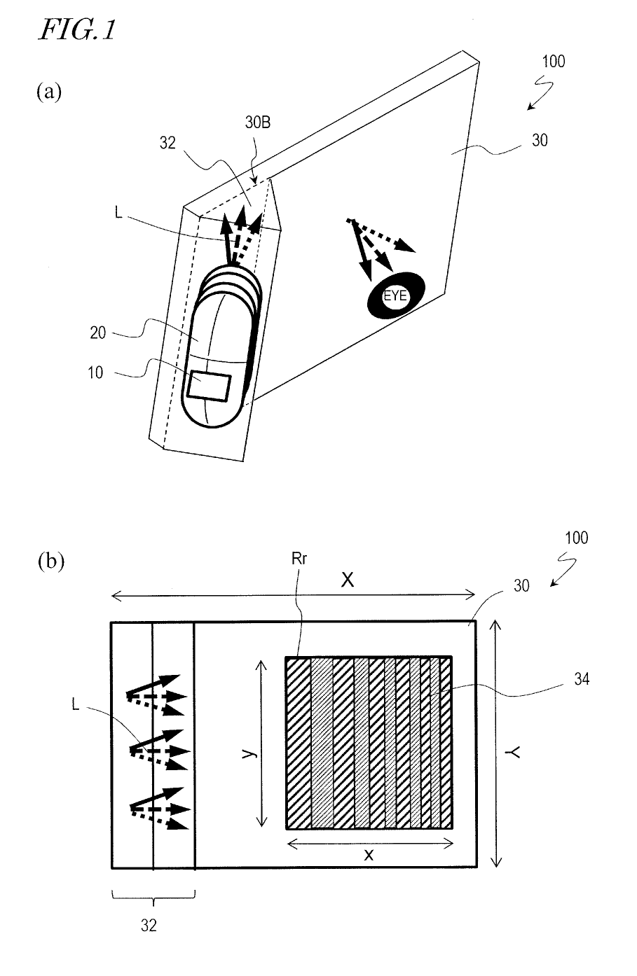

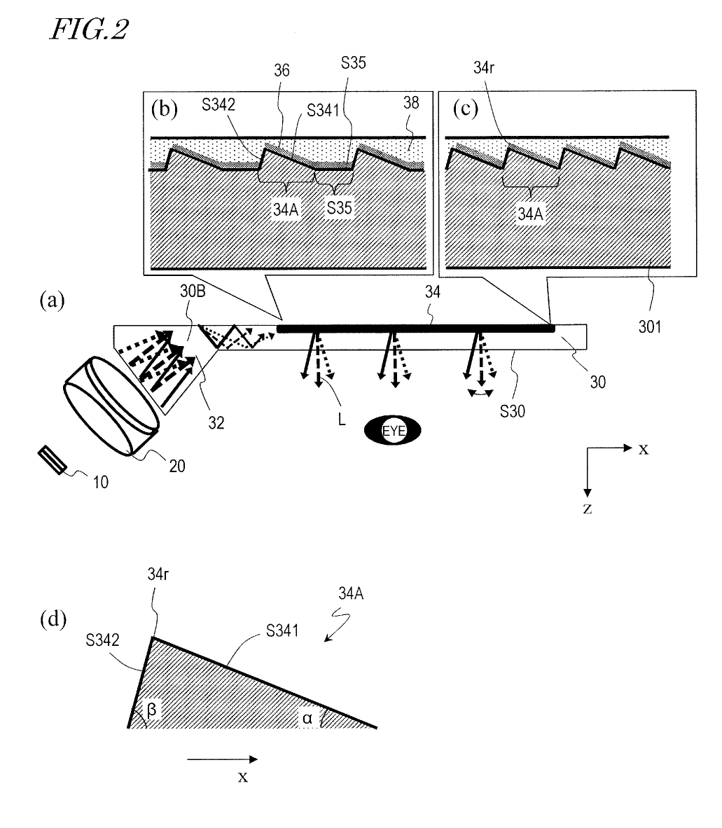

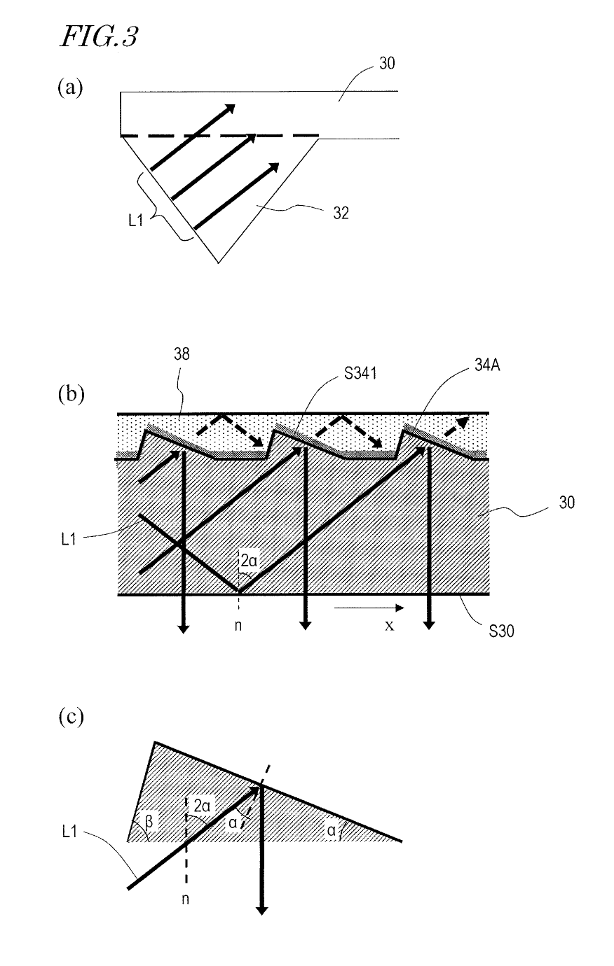

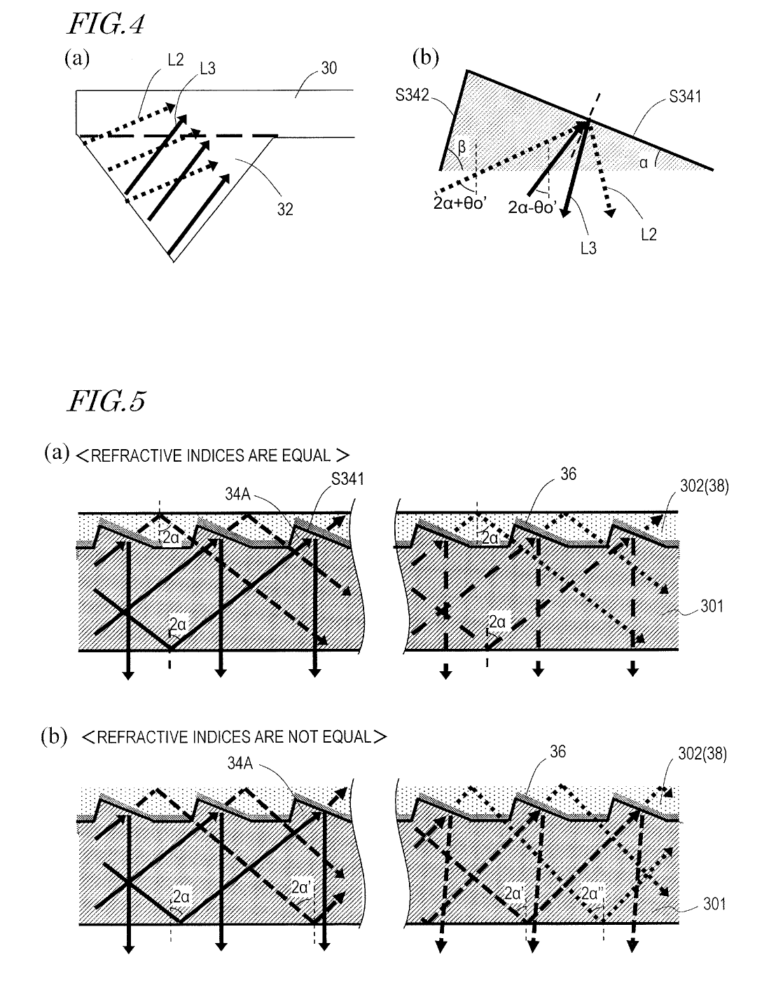

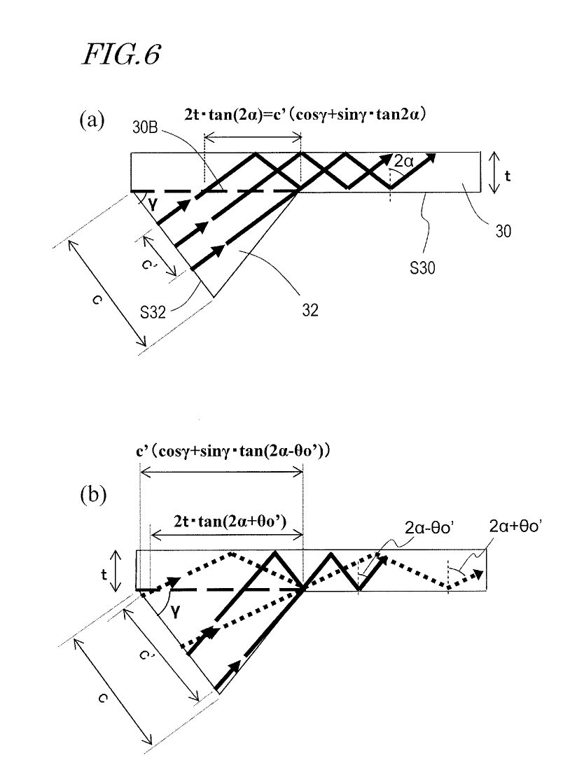

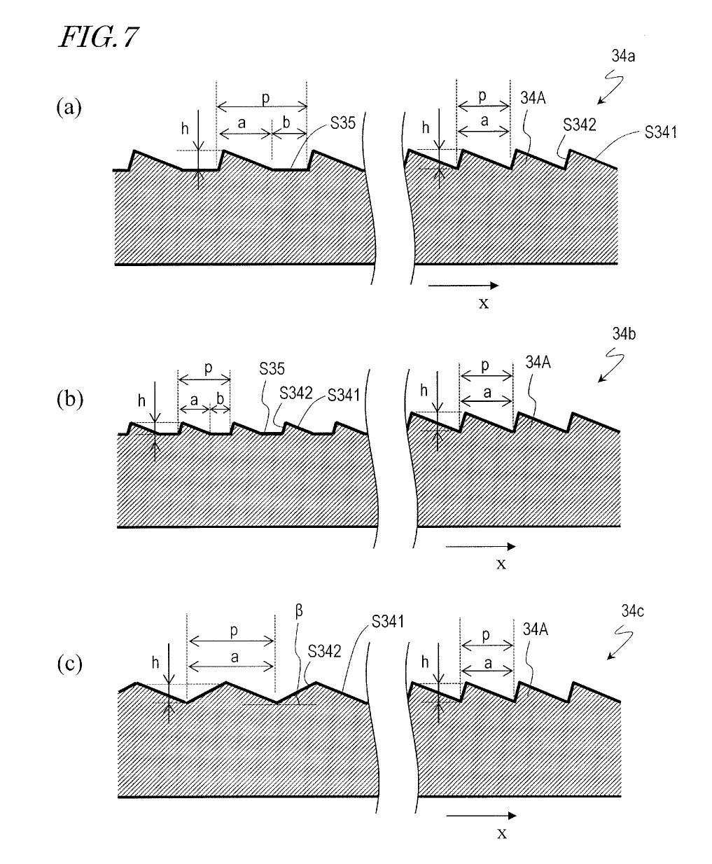

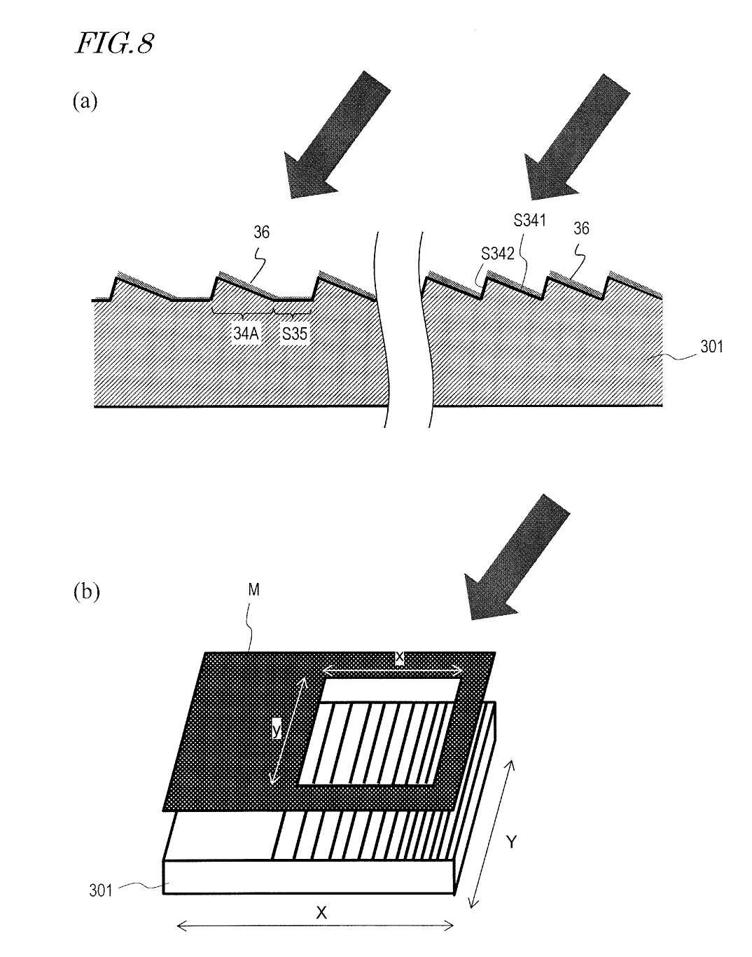

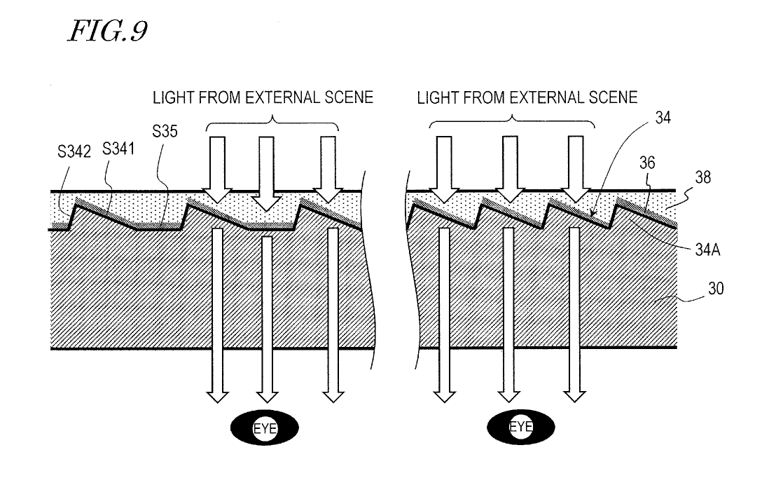

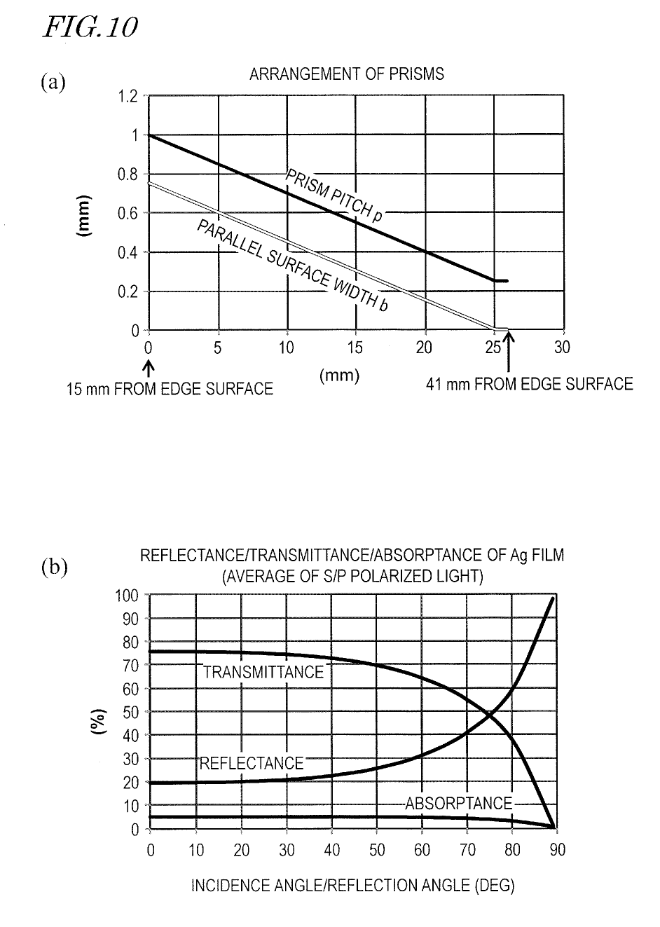

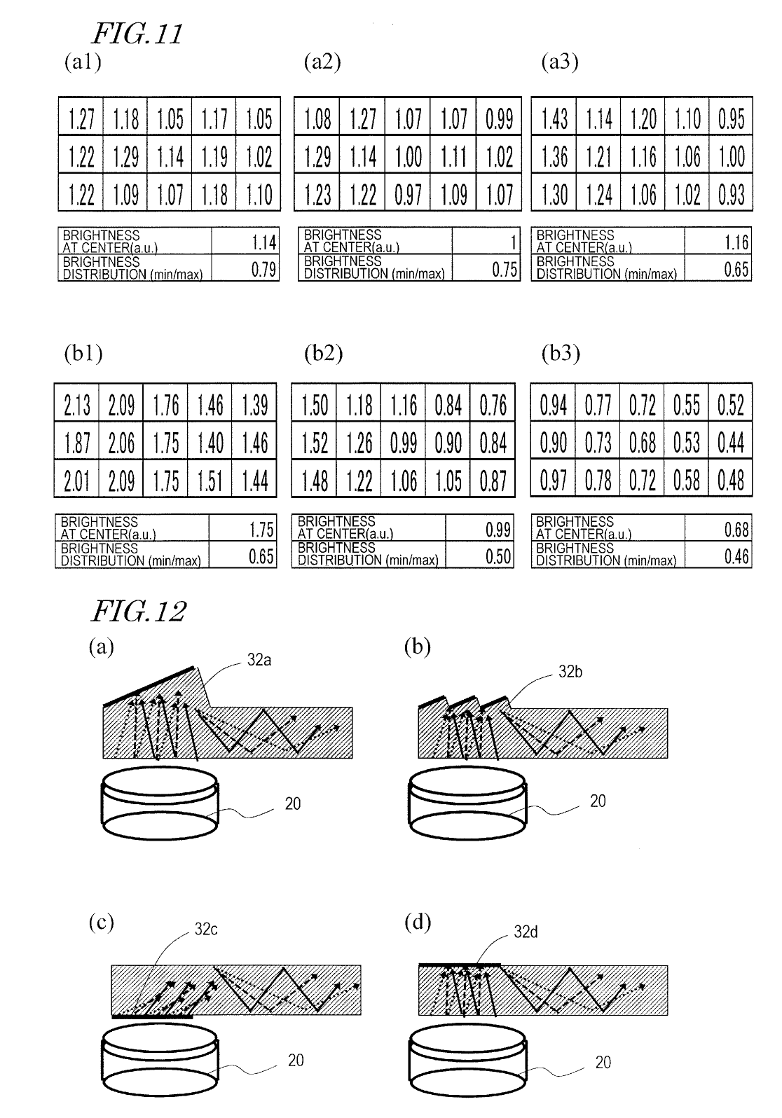

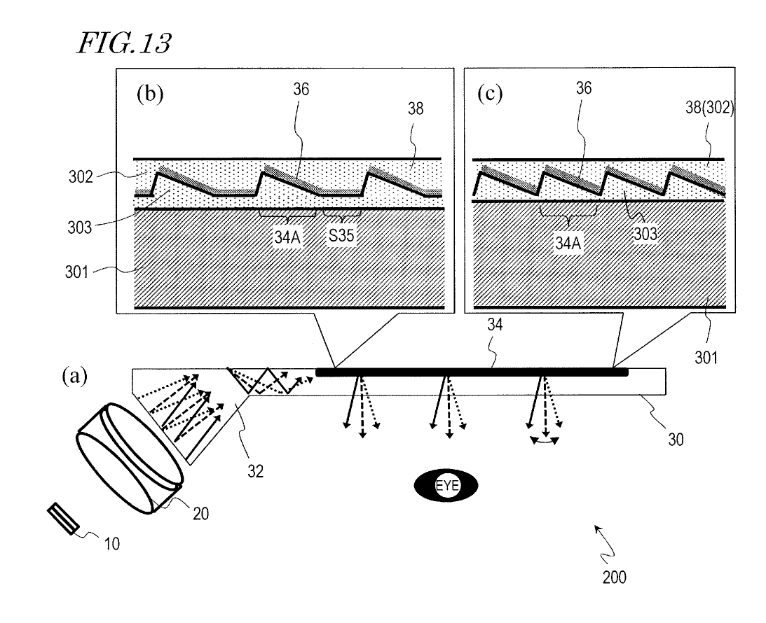

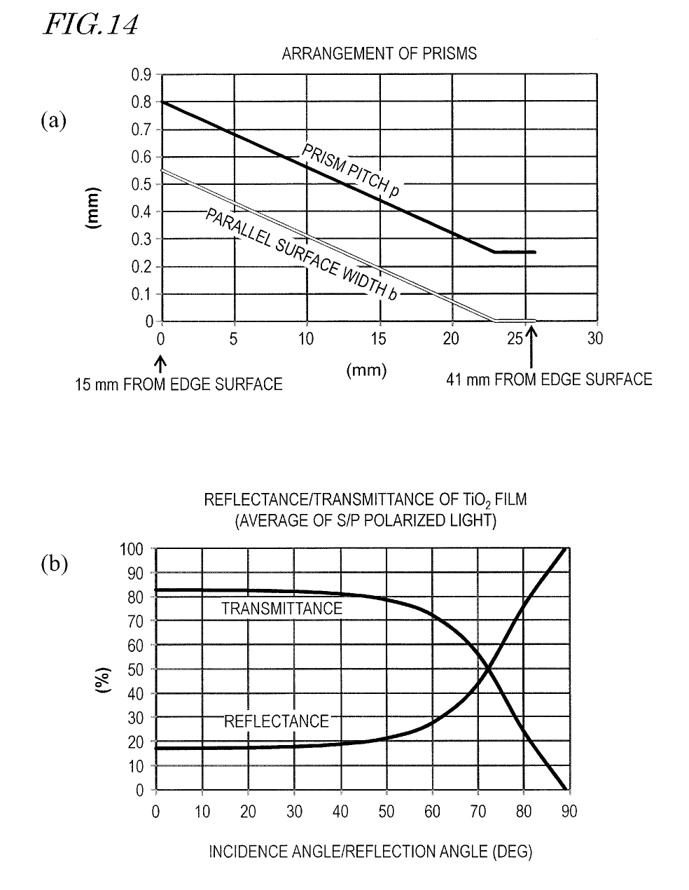

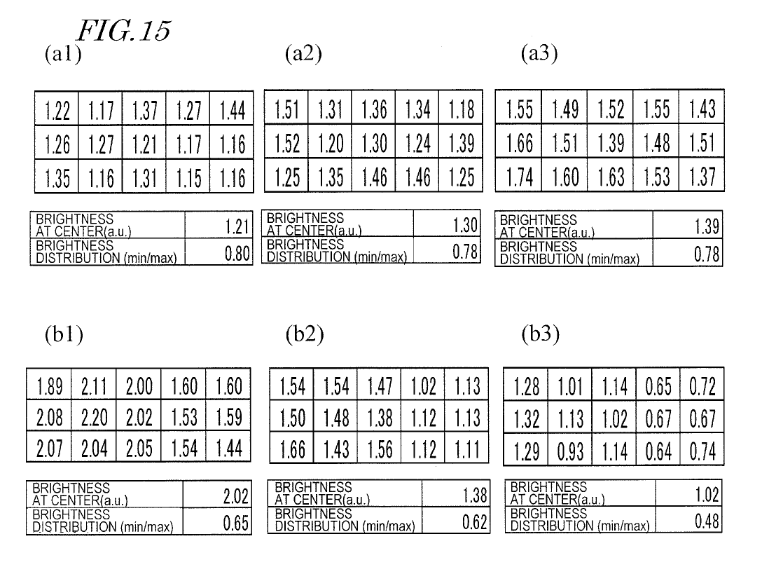

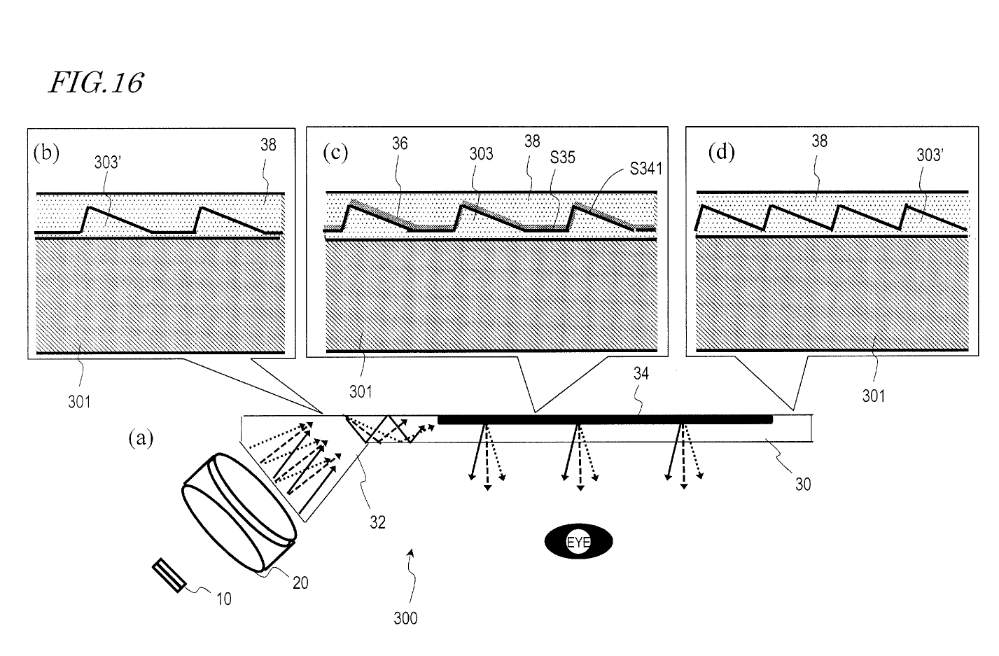

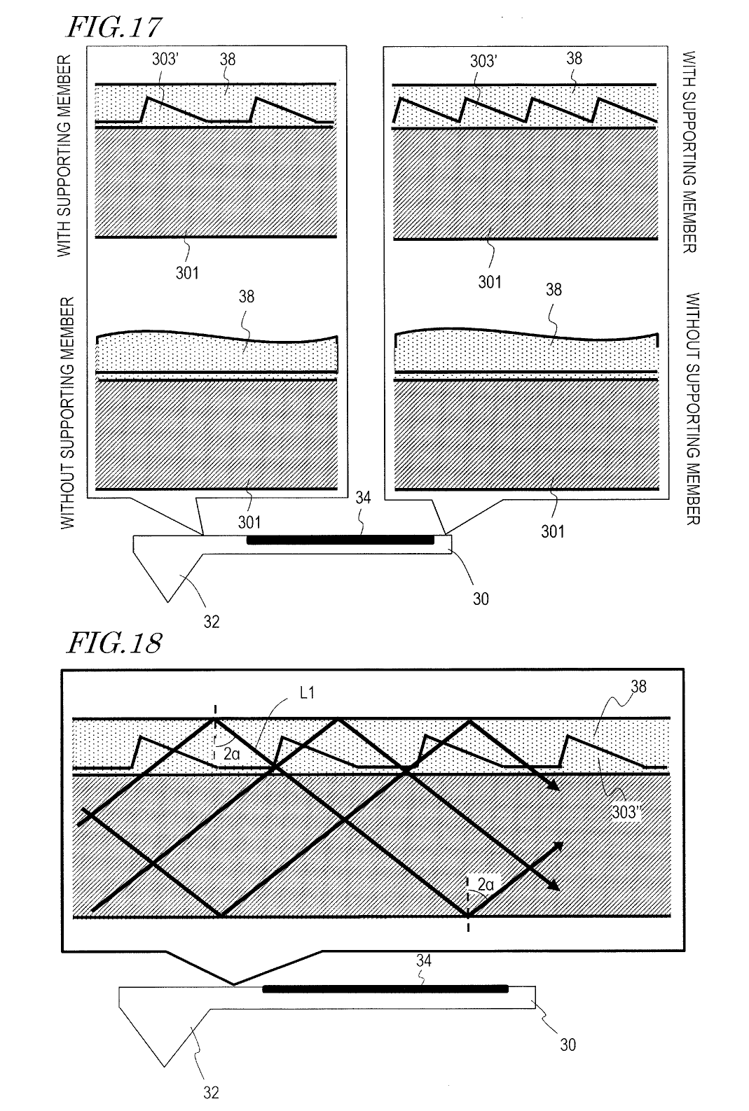

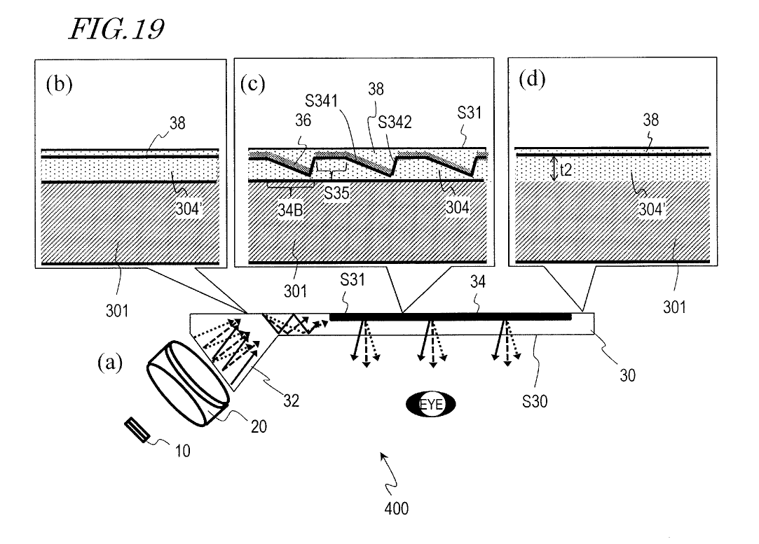

### BRIEF DESCRIPTION OF DRAWINGS

[FIG. 1] Diagrams showing a virtual image display device according to Embodiment 1 of the present invention. (a) is a perspective view. (b) is a plan view.

[FIG. 2] A diagram schematically showing the virtual image display device of Embodiment 1. (a) is a side view showing the entire configuration. (b) is a cross-sectional view showing the arrangement of prisms in part of a prism reflection array region which is near a coupling structure. (c) is a cross-sectional view showing the arrangement of prisms in part of the prism reflection array region which is distant from the coupling structure. (d) is a cross-sectional view showing a single prism.

[FIG. 3] Diagrams illustrating paths of virtual image projecting light in a lightguide of the virtual image display device of Embodiment 1. (a) is a cross-sectional view illustrating paths of light in the coupling structure. (b) is a cross-sectional view illustrating paths of light in the prism reflection array. (c) is a cross-sectional view illustrating a path of light reflected by a prism.

[FIG. 4] Diagrams illustrating paths of outgoing light which are deviated from the normal direction by the angle of view ±θ₀. (a) is a cross-sectional view illustrating paths of light in the coupling structure. (b) is a cross-sectional view illustrating paths of light reflected by a prism.

[FIG. 5] Cross-sectional views illustrating paths of light in the prism reflection array. (a) illustrates a case where a lower transparent member and a planarizing layer have equal refractive indices. (b) illustrates a case where the lower transparent member and the planarizing layer have different refractive indices.

[FIG. 6] Cross-sectional views illustrating paths of light entering the coupling structure. (a) illustrates paths of light outgoing in the normal direction near the coupling structure. (b) illustrates paths of light outgoing in a direction deviated from the normal direction by the angle of view ±θ₀ near the coupling structure.

[FIG. 7] Cross-sectional views showing examples of the arrangement pattern of prisms in the prism reflection array. (a) to (c) show different configurations.

[FIG. 8] Diagrams illustrating the step of forming a semi-reflective film in the prism reflection array. (a) is a cross-sectional view for illustrating oblique evaporation. (b) is a perspective view for illustrating a configuration where a mask is provided such that a semi-reflective film is provided in a predetermined region.

[FIG. 9] A cross-sectional view showing the state of use of the virtual image display device of Embodiment 1.

[FIG. 10] (a) is a graph illustrating the variations of the prism pitch and the like in Example 1. (b) is a graph illustrating the incidence angle (reflection angle) dependence of the transmittance, reflectance and absorptance of the semi-reflective film in Example 1.

[FIG. 11] Tables for illustrating the difference in brightness of the virtual image depending on the position in Example 1 and Comparative Example 1. (a1) to (a3) correspond to Example 1. (b1) to (b3) correspond to Comparative Example 1.

[FIG. 12] Diagrams illustrating various configurations of the coupling structure. (a) to (d) show different configurations.

[FIG. 13] A diagram schematically showing a virtual image display device of Embodiment 2. (a) is a side view showing the entire configuration. (b) is a cross-sectional view showing the arrangement of prisms in part of a prism reflection array region which is near a coupling structure. (c) is a cross-sectional view showing the arrangement of prisms in part of the prism reflection array region which is distant from the coupling structure.

[FIG. 14] (a) is a graph illustrating the variations of the prism pitch and the like in Example 2. (b) is a graph illustrating the incidence angle (reflection angle) dependence of the transmittance, reflectance and absorptance of the semi-reflective film in Example 2.

[FIG. 15] Tables for illustrating the difference in brightness of the virtual image depending on the position in Example 2 and Comparative Example 2. (a1) to (a3) correspond to Example 2. (b1) to (b3) correspond to Comparative Example 2.

[FIG. 16] A diagram schematically showing a virtual image display device of Embodiment 3. (a) is a side view showing the entire configuration. (b) is a cross-sectional view showing the configuration of a light guide plate in a region which is outside a prism reflection array and which is near a coupling structure. (c) is a cross-sectional view showing the arrangement of prisms in the prism reflection array. (d) is a cross-sectional view showing the configuration of the light guide plate in a region which is outside the prism reflection array and which is distant from the coupling structure.

[FIG. 17] A cross-sectional view showing the shape of the surface of the light guide plate in a case where a transparent supporting member is included as in the virtual image display device of Embodiment 3 and a case where a transparent supporting member is not included unlike the virtual image display device of Embodiment 3.

[FIG. 18] A cross-sectional view illustrating paths of light in the virtual image display device of Embodiment 3.

[FIG. 19] A diagram schematically showing a virtual image display device of Embodiment 4. (a) is a side view showing the entire configuration. (b) is a cross-sectional view showing the configuration of a light guide plate in a region which is outside a prism reflection array and which is near a coupling structure. (c) is a cross-sectional view showing the arrangement of prisms in the prism reflection array. (d) is a cross-sectional view showing the configuration of the light guide plate in a region which is outside the prism reflection array and which is distant from the coupling structure.

### DESCRIPTION OF EMBODIMENTS

Hereinafter, a lightguide of an embodiment of the present invention and a virtual image display device which includes the lightguide are described with reference to the drawings. Here, a configuration of a head mount display (HMD) is described as an example of the virtual image display device although the present invention is not limited to this example. The lightguide which will be described below can be used not only in a HMD but also in a virtual image display device of a different form, such as a head up display (HUD).

### Embodiment 1

FIGS. 1(a) and 1(b) are a perspective view and a plan view schematically showing the configuration of a virtual image display device 100 of Embodiment 1. FIG. 2(a) is a side view schematically showing the configuration of the virtual image display device 100.

The virtual image display device 100 includes a display element 10 and a projection lens system (collimation optical system) 20 which is capable of receiving and collimating light emitted from the display element 10. The virtual image display device 100 further includes a light guide plate 30 in the shape of a flat plate for receiving light emitted from the projection lens system 20.

At an end portion of one of the major surfaces of the light guide plate 30, a coupling structure 32 is provided for receiving light L from the projection lens system 20. In the present embodiment, the coupling structure 32 used is a prism which is in the shape of a triangular prism extending along one side of the light guide plate 30 (Y direction shown in FIG. 1(b)). Note that, in this specification, an optical element including the light guide plate 30 and the coupling structure 32 is also referred to as “lightguide”.

In this configuration, light L emitted from the display element 10 (image displaying light) is collimated by the projection lens system 20 and thereafter enters the coupling structure 32 provided at an end portion of the light guide plate 30. The collimated beam light (virtual image projecting light) which has entered the coupling structure 32 travels through the inside of the light guide plate 30 mainly in the first direction from a light receiving section 30B at the end portion of the light guide plate 30, i.e., from a portion at which the coupling structure 32 is provided. Here, the first direction means an in-plane direction from the coupling structure 32 to the opposite side of the light guide plate 30, i.e., the X direction shown in FIG. 1(b) (a direction which is perpendicular to the aforementioned Y direction in a plane).

Note that the light L guided from the coupling structure 32 into the light guide plate 30 includes a plurality of light beams which have slightly different traveling directions as shown in FIG. 1 and FIG. 2. Here, light emitted from a central region of the display element 10 corresponds to a light beam traveling in a direction parallel to the X direction shown in FIG. 1(b). Light emitted from a peripheral region of the display element 10 corresponds to a light beam traveling in a direction not parallel to the X direction.

The display element 10 and the projection lens system 20 can be selected from a wide variety of known display elements and known lens systems. The display element 10 can be, for example, a transmissive liquid crystal display panel or an organic EL display panel, and the projection lens system 20 can be, for example, a lens system disclosed in Japanese Laid-Open Patent Publication No. 2004-157520. Alternatively, the display element 10 can be a reflective liquid crystal display panel (LCOS), and the projection lens system 20 can be, for example, a concave mirror or lens system disclosed in Japanese Laid-Open Patent Publication No. 2010-282231. The entire disclosures of Japanese Laid-Open Patent Publication No. 2004-157520 and Japanese Laid-Open Patent Publication No. 2010-282231 are incorporated by reference in this specification. The size of the display element 10 is, for example, about 0.2 inch to about 0.5 inch in diagonal. Note that the diameter of a light beam emitted from the projection lens system 20 may be modified by the projection lens system 20. By modifying the size of the coupling structure 32, the diameter of the light beam can be increased.

The light guide plate 30 is formed using a flat plate which is made of, for example, a transparent resin material or glass. The major surfaces of the light guide plate 30 are exposed to air. Therefore, as shown in FIG. 2(a), light entering from the light receiving section 30B of the light guide plate 30 and traveling through the inside of the light guide plate 30 can be totally reflected by the upper and lower major surfaces of the light guide plate 30. More specifically, light impinging on the upper and lower major surfaces of the light guide plate 30 at an incidence angle equal to or greater than the critical angle that is determined depending on the relative refractive index of the light guide plate 30 with respect to the external medium (here, air) is totally reflected by an interface. Then, the light travels through the inside of the light guide plate 30 mainly in the first direction (X direction) while repeatedly undergoing total reflection. Note that, in this specification, for the sake of convenience, the major surfaces of the light guide plate 30 are sometimes distinguishably referred to as “upper surface” and “lower surface” according to the drawings. However, as a matter of course, they do not intend to define relative vertical positions when the light guide plate 30 is actually used.

The light guide plate 30 includes a prism reflection array 34. As shown in FIG. 1(b), the prism reflection array 34 is provided in a rectangular region Rr which has width x in the X direction and width y in the Y direction in a plane of the light guide plate 30. As shown in FIG. 2(a), light entering from the light receiving section 30B that is provided at an end portion of the light guide plate 30 and traveling through the inside of the light guide plate 30 while repeatedly undergoing total reflection is reflected by the prism reflection array 34 and outgoes from a light exit surface S30 that is the lower surface of the light guide plate 30. The prism reflection array 34 is configured such that light outgoes mainly in the normal direction of the light exit surface S30. Note that the normal direction of the light exit surface S30 corresponds to the Z direction that is perpendicular to the aforementioned X and Y directions.

As shown in FIGS. 2(b) and 2(c), the prism reflection array 34 includes a plurality of prisms 34A. Each of the prisms 34A has a first slope surface S341 which is inclined within a predetermined angle range with respect to the light exit surface S30 of the light guide plate 30 and a second slope surface S342 connecting with the first slope surface S341 at the ridge 34r of the prism. In each of the prisms 34A, the first slope surface S341 is a slope surface provided on a side which is more distant from the light receiving section 30B than the second slope surface S342.

As shown in FIG. 2(d), the angle between the first slope surface S341 and a plane which is parallel to the light exit surface S30 (hereinafter, also referred to as “X-Y plane”) is referred to as “angle α”, and the angle between the second slope surface S342 and the X-Y plane is referred to as “angle β”. The angle α is for example 10° to 45°, and the angle β is for example 60° to 90°. Now, as shown in FIG. 2(d), consider a cross section where a direction from an end portion of the light guide plate 30 at which the light receiving section 30B is provided to the other end portion is the positive X direction. In this cross section, the slope angle α of the first slope surface S341 is such an angle that the clockwise deviation of the first slope surface S341 from the X-Y plane (0°) is designated by a positive value. The slope angle β of the second slope surface S342 is such an angle that the counterclockwise deviation of the second slope surface S342 from the X-Y plane (0°) is designated by a positive value.

A semi-reflective film 36 is provided on the prisms 34A so as to be in contact with, and to selectively cover, the first slope surface S341 and a parallel surface S35 which will be described later. The semi-reflective film 36 is realized by, for example, a thin metal or dielectric film and is capable of reflecting part of incident light and transmitting another part of the light. In this configuration, light traveling through the inside of the light guide plate 30 can be partially reflected by the first slope surface S341 and the parallel surface S35, while light incoming from above the upper surface of the light guide plate 30 (external light) can be transmitted to the lower surface side of the light guide plate 30.

A planarizing layer 38 is provided so as to cover the prism reflection array 34 on which the semi-reflective film 36 is provided. The planarizing layer 38 is provided so as to fill the uneven structure of the prism reflection array 34 formed in a lower transparent member 301 that is a constituent of the light guide plate 30, and to planarize the upper surface of the light guide plate 30. Light traveling through the inside of the light guide plate 30 and transmitted through the semi-reflective film 36 can be totally reflected by the upper surface of the planarizing layer 38, and therefore, the light travels through the inside of the light guide while repeatedly undergoing total reflection and reaches the prism reflection array 34.

As shown in FIG. 2(b), in the prism reflection array 34 provided in the light guide plate 30 of the present embodiment, there is a slit-like flat portion (parallel surface S35) between adjoining prisms 34A at a position near the coupling structure 32 (or the light receiving section 30B). Meanwhile, as shown in FIG. 2(c), at a position distant from the coupling structure 32 (or the light receiving section 30B), the aforementioned flat portion is not provided between adjoining prisms 34A, so that the prisms 34A closely adjoin each other.

Now, the reasons why the arrangement pattern of the prisms varies depending on the position on the prism reflection array 34 are described. When light reflected by the prism reflection array 34 outgoes from the light guide plate 30, there is a probability that the viewed brightness varies depending on the position on the exit surface S30. One of the reasons for this is that if the distribution of the reflecting surface is uniform across the reflector member provided in the light guide plate 30 (here, the prism reflection array 34), the intensity of outgoing collimated beam light is high on a side which is close to the light receiving section 30B into which light from the display element 10 enters, while the intensity of outgoing collimated beam light is low on a side which is distant from the light receiving section 30B.

To reduce such in-plane nonuniformity in intensity of the outgoing light, modifying the reflectance of the reflector member according to the position on the light exit surface is considered. For example, Patent Document 2 discloses that the reflectance of the reflector member is greater as the distance from a light-entering portion of the light guide plate increases. When a metal film (e.g., Al film) is used as the reflector member, the reflectance can be changed by modifying its thickness. Alternatively, when a dielectric film (e.g., TiO₂ film) is used as the reflector member, the reflectance can be changed by modifying its refractive index.

However, producing the light guide plate such that the thickness or refractive index of the reflector film varies for the purpose of varying the reflectance of the reflector member leads to the problem of complicated manufacture. Further, if the varying thickness or refractive index of the reflector film causes the transmittance of the light guide plate to vary depending on the position at which the light outgoes, the appearance of a viewed external scene disadvantageously varies depending on the position of an eye or viewing direction of a viewer.

In view of such, the prism reflection array 34 of the present embodiment is configured such that the area ratio of the first slope surface S341 per unit area in the exit surface varies depending on the position on the exit surface. To this end, as shown in FIG. 2(b), within the region in which the prism reflection array 34 is provided, on a side which is close to the coupling structure 32 (or the light receiving section 30B of the light guide plate 30), a flat portion (parallel surface S35) is provided between adjoining prisms 34A such that the aforementioned area ratio of the slope surface S341 is relatively low. Meanwhile, as shown in FIG. 2(c), on a side which is distant from the coupling structure 32 (or the light receiving section 30B of the light guide plate 30), no flat portion is provided between adjoining prisms 34A such that the prisms 34A are densely arranged, and accordingly, the area ratio of the slope surface S341 is relatively high.

FIG. 2(b) and FIG. 2(c) show the arrangement of the prisms 34A in a region of the prism reflection array 34 which is closest to the coupling structure 32 and the arrangement of the prisms 34A in a region of the prism reflection array 34 which is most distant from the coupling structure 32. In an intermediate region between these regions, a parallel surface whose width is smaller than that of the parallel surface S35 shown in FIG. 2(b) may be provided between adjoining prisms 34A. Specifically, the interval between the prisms 34A (arrangement pitch) or the width of the parallel surface S35 provided between the prisms 34A may decrease gradually or stepwise as the distance from the coupling structure 32 or the light receiving section 30B increases. In the prism reflection array 34, the in-plane density (presence ratio per unit area) of the prisms 34A may increase as the distance from the light receiving section 30B increases.

In such a configuration where the area ratio of the first slope surface S341 varies depending on the position in a plane, an additional reflecting region other than the first slope surface S341 (e.g., the aforementioned parallel surface S35 provided between adjoining prisms) can be provided. Providing such an additional reflecting region can make the in-plane transmittance of the light guide plate 30 uniform. Thus, irrespective of the position in a plane of the light guide plate 30, the brightness of an external scene viewed through the light guide plate 30 can be made uniform while the intensity of the outgoing virtual image displaying light is made uniform.

The semi-reflective film 36 is arranged so as to cover the first slope surface S341 of the prisms 34A and the parallel surface S35. Meanwhile, the second slope surface S342 of the prisms 34A is not provided with the semi-reflective film 36. That is, light traveling through the inside of the light guide plate 30 is reflected by the first slope surface S341 of the prisms 34A and the parallel surface S35 but is not reflected by the second slope surface S342. This is because, if the second slope surface S342 forms a reflecting surface, light is reflected in an unexpected direction, and this reflection becomes stray light, so that it is more difficult to display high quality virtual images.

In the above-described configuration, as the arrangement density of the prisms in the X direction increases as described above, the area ratio per unit area of the reflecting surface formed by the semi-reflective film 36 which covers the first slope surface S341 (also referred to as “slope reflecting surface”) increases when viewed in the normal direction of the light guide plate 30. That is, in the prism array 34A, the area ratio per unit area of the slope reflecting surface is small on a side which is close to the coupling structure 32 (or the light receiving section 30B of the light guide plate 30) but large on a side which is distant from the coupling structure 32 (or the light receiving section 30B of the light guide plate 30).

This enables to extract virtual image reflected light uniformly within the region in which the prism reflection array 34 is provided. Since in the above-described configuration the semi-reflective film 36 is also provided on the parallel surface S35 between the prisms, the transmittance of the light guide plate 30 would not largely vary over the entirety of the prism reflection array 34. Thus, the brightness of an external scene viewable through the light guide plate 30 is prevented from largely varying depending on the position or viewing direction of a viewer.

Next, the slope angle α of the first slope surface S341 of the prisms 34A is described with reference to FIGS. 3(a) to 3(c). As shown in FIG. 3(a), light L1 emitted from a central region of the display element 10 (see FIG. 1(a) and FIG. 2(a)) travels through the coupling structure 32 and enters into the light guide plate 30. Note that light emitted from an edge region of the display element 10 also travels through the coupling structure 32 and enters into the light guide plate 30. However, these light L2, L3 enter the coupling structure 32 at different angles from that of the light L1 that comes from the central region as shown in FIGS. 4(a) and 4(b). First, the path of virtual image projecting light L1 that comes from a pixel of the central region of the display element 10 is described with reference to FIGS. 3(a) to 3(c).

As shown in FIG. 3(b), light L1 which enters the light guide plate 30 and travels mainly in the X direction while repeatedly undergoing total reflection is reflected by the first slope surface S341 of the prisms 34A. The reflected light typically outgoes in the normal direction n of the light exit surface S30 of the light guide plate 30.

Here, when light L1 outgoes in the normal direction n of the light exit surface S30, light L1 is incident on the first slope surface S341 of the prisms 34A at incidence angle α (which is equal to the slope angle α of the first slope surface S341). As shown in FIG. 3(c), this light that is incident on the first slope surface S341 at incidence angle α is light which travels through the inside of the light guide plate 30 in a direction different from the normal direction n by an angle of 2α and which is totally reflected by the lower surface of the light guide plate 30 as shown in FIG. 3(b). Thus, in order that light travels through the inside of the light guide plate 30 while repeatedly undergoing total reflection and reaches the first slope surface S341 and is then reflected by the first slope surface S341 so as to outgo in the normal direction n, the condition of 0c≦2α<90° needs to be met. Here, θc represents the critical angle of the light guide plate 30. Light which is incident on the upper and lower surfaces of the light guide plate 30 at an incidence angle equal to or greater than the critical angle θc is totally reflected. For this reason, the first slope angle α of the prisms is preferably set so as to meet the condition of θc/2≦α<45°.

As shown in FIGS. 4(a) and 4(b), in the virtual image display device 100, light can outgo in the angle range of the angle of view ±θ₀ in the horizontal direction (the traveling direction of virtual image projecting light inside the light guide plate: the above-described X direction), i.e., within the angle range of ±θ₀ where the normal direction n is the center (0°). As shown in FIG. 4(b), light L2, L3 are light which travels through the inside of the light guide plate 30 in a direction different from the normal direction n by an angle of 2α±θ₀′ and is reflected by a reflecting surface which has the slope angle α, where ±θ₀′ is the incidence angle on the light guide plate side of light L2, L3 outgoing from the light exit surface at an angle of ±θ₀ (refraction angle). Therefore, as in the previously-described example, the condition of θc≦2α±θ₀′<90° needs to be met in order that light which travels through the inside of the light guide plate 30 and is then reflected by a slope surface with a slope angle α outgoes at the angle of view ±θ₀. That is, when the condition of θc+θ₀′≦2α<90−θ₀′ is met, the virtual image projecting light L2, L3 appropriately outgoes in the direction of the angle of view ±θ₀.

When the direction in which display light emitted from the central region of the display element 10 is collimated is regarded as the center direction, the direction in which display light emitted from pixels at the edges of the display regions (upper edge, lower edge, left edge and right edge) is collimated forms a predetermined angle with the center direction. The light outgoing in a direction deviated from the normal direction of the light exit surface shown in FIGS. 4(a) and 4(b) may be, for example, light emitted from a pixel at an edge of the display element 10.

FIGS. 5(a) and 5(b) illustrate the paths of light in the lower transparent member 301 that is a constituent of the light guide plate 30 in a case where the refractive index n1 of the lower transparent member 301 which includes the prisms 34A is generally equal to the refractive index n2 of an upper transparent member 302 that is the planarizing layer 38 covering the prisms 34A and a case where the refractive index n1 is not equal to the refractive index n2.

As shown in FIG. 5(a), when the lower transparent member 301 that includes the prisms 34A and the upper transparent member 302 that covers the prisms 34A have equal refractive indices, light entering from the coupling structure into the light guide plate travels through the inside of the light guide plate 30 while repeatedly undergoing total reflection at the maintained reflection angle 2α. In this case, part of the light passes through the semi-reflective film 36 provided on the first slope surface S341 and enters into the upper transparent member 302. However, the light is reflected by the surface of the upper transparent member 302 at the maintained reflection angle 2α. Therefore, in the same fashion as the light reflected without transmission through the semi-reflective film 36, the light can be reflected by the reflecting surface that has the slope angle α so as to go out of the light guide plate 30 in the normal direction n of the light exit surface S30.

On the other hand, as shown in FIG. 5(b), when the lower transparent member 301 that includes the prisms 34A and the upper transparent member 302 that covers the prisms 34A have different refractive indices, light transmitted through the semi-reflective film 36 is refracted at an angle which depends on the relative refractive indices of the lower transparent member 301 and the upper transparent member 302. Therefore, the light transmitted through the semi-reflective film 36 is reflected at a different reflection angle 2α′, rather than reflection angle 2α, while traveling through the inside of the light guide plate 30. Accordingly, unlike the light reflected without being transmitted through the semi-reflective film 36, the light transmitted through the semi-reflective film 36 can outgo in a direction deviated from the normal direction n of the light exit surface S30. Light transmitted through the semi-reflective film 36 multiple times is reflected at a still different reflection angle 2α″ while traveling through the inside of the light guide plate 30, and therefore can outgo in a direction still deviated from the normal direction n of the light exit surface S30. Since the angle of the outgoing light thus varies at every transmission through the semi-reflective film 36, the problem of deterioration in display quality due to blurring of viewed virtual images can arise as a result.

As understood from the foregoing, the display quality can be improved so long as the refractive index n1 of the lower transparent member 301 that forms the prisms 34A and the refractive index n2 of the upper transparent member 302 that covers the prisms 34A match with each other.

Next, the shape of the coupling structure 32 is described with reference to FIGS. 6(a) and 6(b).

As described above, in the present embodiment, the coupling structure 32 has the shape of a triangular prism. The coupling structure 32 has an elongated slope surface S32 which is inclined with respect to the light exit surface S30. The slope surface S32 serves as a light receiving surface. Light emitted from the display element 10 is collimated by the projection lens system 20 before impinging on this slope surface S32.

In this case, as for light emitted from a central region of the display element 10, a condition which allows the light guided into the light guide plate 30 via the coupling structure 32 to uniformly reach the entirety of the prism reflection array 34 (see FIG. 3 and others) is that light impinging on the light receiving section 30B has a horizontal width of 2t·tan 2α or more as shown in FIG. 6(a). Here, t represents the thickness of the light guide plate 30. If the impinging light has a smaller width, a region where no light travels can be formed inside the light guide plate 30, and there is a probability that the light only locally reaches the prism reflection array 34. In such a case, there is a probability that reflection which is uniform across a plane is not achieved.

Meanwhile, the width of collimated beam light at the light receiving surface S32 of the coupling structure 32 is c′. The light which has this width c′ then has a horizontal width of c′(cos(γ)+sin(γ)tan(2α)) at the light receiving section 30B of the light guide plate. Here, γ is the angle between the light receiving surface S32 of the coupling structure 32 and the lower surface of the light guide plate. In this case, from the viewpoint of easily achieving reflection which is uniform in a plane, it is desired that c′(cos(γ)+sin(γ)tan(2α)) is not less than 2t·tan 2α.

In this case, as for the width c of the light receiving surface S32 of the coupling structure 32, it is desired that the horizontal width of the light receiving surface S32, c(cos(γ)+sin(γ)tan(2α)), is not less than aforementioned 2t·tan 2α. That is, it is preferred that c(cos(γ)+sin(γ)tan(2α))≧2t·tan 2α is met. When this condition is met, the coupling structure 32 is capable of appropriately receiving collimated beam light which has a sufficient width c′ and guiding the collimated beam light uniformly to the entirety of the prism reflection array 34 without hindering the travel of the light.

By thus appropriately selecting the shape and size of the coupling structure, the virtual image projecting light received by the prism reflection array 34 can be prevented from varying depending on the position. As a result, virtual image light extracted from the light guide plate can be prevented from having unevenness, and displaying of high quality virtual images can be realized.

Note that, as shown in FIG. 6(b), when the angle of view (±θ₀) in the horizontal direction of virtual images is considered, it is preferred that the width c and slope angle γ of the light receiving surface S32 meet the condition of c(cos(γ)+sin(γ)tan(2α−θ₀′))≧2t·tan(2α+θ₀′), with the use of the above-described refraction angle ±θ₀′. In this case, virtual image light extracted from the light guide plate can be prevented from having unevenness, and displaying of high quality virtual images can be realized.

Note that the above-described width c of the light receiving surface S32 of the coupling structure 32 is a width which is defined in a direction perpendicular to the intersection of the light receiving surface S32 and the exit surface S30 (X-Y plane), and is a dimension of the light receiving surface S32 which is defined in a direction of angle γ in the X-Z plane (cross section).

FIGS. 7(a) to 7(c) show various configurations where the area ratio per unit area of the slope reflecting surface of the prisms 34A varies along the X direction in the prism reflection array.

In a prism reflection array 34a shown in FIG. 7(a), where the arrangement pitch of the prisms 34A is p, the prism width is a, and the width of the parallel surface S35 is b, the width b of the parallel surface S35 between prisms decreases along the X direction while the prism width a is kept identical. Accordingly, the pitch p of the prisms 34A decreases along the X direction. Note that, in this configuration, the height h of the prisms 34A is constant.

In a prism reflection array 34b shown in FIG. 7(b), the prism width a increases and the width b of the parallel surface S35 decreases along the X direction while the pitch p of the prisms 34A is kept constant. In this case, the size of the prisms 34A gradually increases along the X direction, and the height h of the prisms 34A also gradually increases. The width b of the parallel surface S35 between prisms decreases along the X direction.

In a prism reflection array 34c shown in FIG. 7(c), no parallel surface is provided between prisms (i.e., prism pitch p=prism width a), and the shape of the prisms 34A varies along the X direction. More specifically, the prisms 34A have a varying shape such that the slope angle β of the second slope surface S342 increases along the X direction. Accordingly, the pitch p of the prisms 34A and the prism width a decrease along the X direction. Note that, however, in this configuration, the height h of the prisms is maintained constant.

In the configurations shown in FIGS. 7(a) and 7(c), the height h of the prisms 34A can be generally uniform across the entirety of the prism reflection array. Therefore, in filling the prism surface with the planarizing layer, the advantage of easily achieving a flat surface is obtained.

Further, the slope angle β of the second slope surface S342 of the prisms 34A is advantageously set to a value as close to 90° as possible such that the semi-reflective film is likely to be selectively formed on the first slope surface S341 and the parallel surface S35. From such a viewpoint, the configurations shown in FIGS. 7(a) and 7(b) are preferred.

As described above, the arrangement pattern of the prisms can be selected from various forms. However, in order to project virtual image light onto eyes of a viewer via the prism reflection array, it is desired that the prism pitch p is smaller than the pupil diameter. Note that the pupil diameter varies from about 2 mm to about 8 mm depending on the environment. Therefore, when the maximum prism pitch p in the prism reflection array is set to 2 mm or smaller, an appropriate virtual image is easily shown to a viewer irrespective of the environment.

Next, a manufacturing method of the virtual image display device 100 is described. As shown in FIG. 2(a), the virtual image display device 100 includes the display element 10, the projection lens system 20 and the light guide plate 30, which are appropriately arranged. The display element 10 and the projection lens system 20 can be selected from various forms as described above. The display element 10, the projection lens system 20 and the light guide plate 30 only need to be appropriately arranged by a known method according to the use of the virtual image display device 100, and detailed description thereof is herein omitted. Hereinafter, a manufacturing process of a lightguide of the present embodiment which is formed by the light guide plate 30 and the coupling structure 32 is described.

In the present embodiment, the coupling structure 32 is provided at the edge of the light guide plate 30. The coupling structure 32 can be formed integrally with the light guide plate 30 by injection molding. Note that, however, the present invention is not limited to this example. The coupling structure 32 may be formed separately from the light guide plate 30 and thereafter adhered to the light guide plate 30.

Further, the light guide plate 30 includes the prism reflection array 34. In the present embodiment, to form the prism reflection array 34, a lower transparent member is first produced which has a prism array in the surface. Such a lower transparent member can be produced using a known method such as injection molding and press molding, for example. Alternatively, as will be described later in the section of Embodiment 2, the prism array may be separately provided on the lower transparent member by a 2p process (Photo Polymerization Process) or the like. In this case, the lower transparent member and the prism array may be made of different materials.

Next, the step of forming a semi-reflective film 36 on a lower transparent member 301 that has a prism array at the surface is described with reference to FIGS. 8(a) and 8(b).

As shown in FIG. 8(a), it is preferred that the semi-reflective film 36 is provided on the first slope surface S341 of the prisms 34A (and the parallel surface S35) and is not provided on the second slope surface S342. This is because, if the second slope surface S342 is reflective, virtual image light traveling through the inside of the light guide plate is reflected in a direction different from the predetermined direction (typically, the normal direction of the light exit surface) so that blurring of the virtual image and ghosts occur.

Thus, in the present embodiment, as shown in FIG. 8(a), the semi-reflective film 36 is formed on the first slope surface S341 and the parallel surface S35 by a deposition method which has anisotropy, such as oblique evaporation. The semi-reflective film 36 formed may be a metal or dielectric film. In the present embodiment, the semi-reflective film 36 used is a 2-5 nm thick Ag film. In the oblique evaporation, deposition is carried out from an oblique direction which faces on the first slope surface S341 but does not face on the second slope surface S342 (e.g., the normal direction of the first slope surface S341) rather than from the normal direction of the lower transparent member 301.

Further, as shown in FIG. 8(b), the semi-reflective film 36 may be formed by deposition via a mask M so as to be within a rectangular region whose widths, x and y, are smaller than the external dimensions of the transparent member (light guide plate). The rectangular region which has the widths of x and y is a region in which the prism array is provided. In this region, the prism reflection array 34 is formed. Note that a semi-reflective film may be formed over the entire lower transparent member without using the mask M. However, in this case, it is preferred that the prism array is not provided in a region other than the region in which the prism reflection array 34 is to be formed.

Note that, in the present embodiment, the prism reflection array 34 is configured to have outwardly-raised prisms at the surface of the lower transparent member 301. However, alternatively, even when the prism reflection array 34 is configured to have inwardly-recessed prisms at the surface of the lower transparent member 301, the prism reflection array 34 can be formed basically in the same way as that described above.

Thereafter, a planarizing layer 38 (e.g., FIG. 2(a)) is formed on the prism array on which the semi-reflective film 36 has been selectively provided as described above. As the material of the planarizing layer 38, a photocurable (UV-curable) resin, a thermosetting resin, a two-component epoxy resin, or the like, can be used. Such a resin material is applied over the prism array and compressed into gaps and, thereafter, the resin is cured by polymerization, whereby the planarizing layer 38 is formed. Note that it is desirable that the refractive index of the material that forms the prism array (here, the lower transparent member 301) is generally equal to the refractive index of the planarizing layer 38.

FIG. 9 is a diagram illustrating the state of use of the virtual image display device 100 of the present embodiment. As illustrated in FIG. 9, the virtual image display device 100 is in the form of, for example, an eyeglass-like head mount display and configured such that the prism reflection array 34 of the light guide plate 30 is located in front of an eye of a user when used.

In this case, light from the display element 10 such as shown in FIG. 1(a) and other drawings is reflected by the prism reflection array 34, so that a viewer can view an image of the display element 10 as a virtual image. Also, light from the external scene behind the semi-reflective film 36 reaches the eye, so that the viewer can also view the rear scene simultaneously through the prism reflection array 34.

In the virtual image display device 100, the ratio per unit area of the first slope surface S341 in a plane is small on a side which is close to the light receiving section of the light guide 30 (the left side in FIG. 9) but large on a side which is distant from the light receiving section of the light guide 30 (the right side in FIG. 9). This arrangement prevents the intensity of the outgoing virtual image displaying light from being high on the side which is close to the light receiving section of the light guide 30 but low on the side which is distant from the light receiving section of the light guide 30, so that a virtual image of uniform brightness can be displayed.

The semi-reflective film 36 is provided not only on the first slope surface S341 but also on the parallel surface S35 between the prisms. In this configuration, only the second slope surface S342 is not covered with the semi-reflective film 36 and, therefore, the ratio of the presence of the semi-reflective film 36 is generally constant over the entirety of the prism reflection array 34. This configuration enables to reduce the location dependence of the transmittance of the light guide plate 30 and, therefore, the variation of the brightness of the environment which occurs depending on the position of the eye of the viewer can be suppressed and, also in other viewing directions than the front viewing direction, the variation of the brightness of the environment within a field of view can be suppressed.

Hereinafter, a more specific example (Example 1) of the virtual image display device 100 of Embodiment 1 is described.

In Example 1, the lower transparent member 301 having the prism array at the surface was formed by injection molding using a “ZEONEX” material manufactured by Zeon Corporation. The injection molding is a molding method in which a resin to be molded is heated so as to have fluidity and injected into a die under high pressure, whereby the shape of the die is transferred to the resin.

The planar size of the lower transparent member 301 (light guide plate 30) was X=45 mm, Y=30 mm. The shape of the prism was α=26°, β=85°. The prism array was provided in a region having the width of x=26 mm, from the position of 15 mm to the position of 41 mm along the X direction, relative to the edge surface at which the coupling structure 32 was provided.

The prism width a was 0.25 mm (a=0.25 mm). The parallel surface width b was gradually decreased from 0.75 mm to 0 mm along the X direction, from the side which is close to the coupling structure 32 to the side which is distant from the coupling structure 32. Therefore, the prism pitch p varies from 1.0 mm to 0.25 mm, but even the maximum prism pitch p (a region nearest to the coupling structure 32) is smaller than the minimum pupil diameter, 2 mm. In this case, the number of prisms included in the prism reflection array 34 is 49. Note that, as the material of the lower transparent member 301, a transparent resin, such as typically acrylic and polycarbonate resins, can alternatively be selected.

To form the semi-reflective film 36, Ag was deposited via a mask by oblique evaporation to a predetermined thickness (about 3 nm) in a rectangular region having a width of x=26 mm in the X direction and a width of y=18 mm in the Y direction. As the material of the semi-reflective film 36, a metal material such as Al or a dielectric material such as TiO₂ can alternatively be used.

The material used for the planarizing layer 38 was a UV-curable resin material “NT-32UV” manufactured by Nitto Denko Corporation. The resin material was applied over the prism reflection array and compressed into gaps and thereafter irradiated with ultraviolet light such that the resin was cured by polymerization. Note that the resin material that forms the planarizing layer 38 can be selected from various other known transparent resins, such as a photocurable (UV-curable) resin, a thermosetting resin, and a two-component epoxy resin. The total thickness of the light guide plate 30 was t=2.2 mm.

Note that the coupling structure 32 was formed integrally with the lower transparent member 301. In the coupling structure 32, the slope angle γ of the light receiving surface was γ=52°, and the width of the light receiving surface was c=6 mm.

It is desirable from the viewpoint of preventing blurring of images that the refractive index of the first transparent material that forms the above-described lower transparent member 301 is generally equal to the refractive index of the second transparent material that forms the planarizing layer 38. The first transparent material “ZEONEX” has a refractive index of 1.53 while the second transparent material “NT-32UV” has a refractive index of 1.52. In the above-described combination of the materials, the refractive indices are generally equal to each other.

The thus-produced light guide plate was combined with a virtual image projector to construct a see-through type virtual image display device (head mount display). Note that the angle of view of virtual images projected by the virtual image projector was ±9.8° in the horizontal direction (the traveling direction of virtual image projecting light in the light guide plate: X direction) and ±5.5° in the vertical direction (Y direction).

FIG. 10(a) is a graph illustrating the prism pitch p and the parallel surface width b corresponding to the prism arrangement positions in the above-described virtual image display device of Example 1. FIG. 10(b) is a graph illustrating the angle dependence of the incidence angle (or reflection angle) as for the transmittance, reflectance and absorptance of a semi-reflective film (Ag film).

As seen from FIG. 10(a), in the prism reflection array, the prism pitch p and the parallel surface width b are large on the side which is close to the light receiving section 30B, while the prism pitch p and the parallel surface width b are small on the side which is distant from the light receiving section 30B. As seen from FIG. 10(b), in the virtual image display device of Example 1, light which is incident generally vertically at the incidence angle of 0° has high transmittance but low reflectance and absorptance. Light which is incident generally horizontally at the incidence angle of 90° has low transmittance but high reflectance. This light has somewhat low absorptance.

Next, how the outgoing light intensity varied in a plane in the case where the prism reflection array was configured as in Example 1 (FIGS. 11(a1) to 11(a3)) and the case where the prism pitch p and the parallel surface width b of the prism reflection array were constant as in Comparative Example 1 (FIGS. 11(b1) to 11(b3)) is described with reference to FIG. 11.

The display region of a virtual image was divided by five in the X direction and by three in the Y direction. The upper parts of FIGS. 11(a1) to 11(a3) and FIGS. 11(b1) to 11(b3) show the relative brightness of the virtual image at the central part of each of the divisional regions (5×3 tables). As will be described later, the numbers shown in respective tables are relative values (a.u.) with respect to the brightness at the center of the virtual image while an eye of a viewer is positioned at the center of the prism reflection array (FIG. 11(a2)), which is assumed as being 1. The lower parts of FIGS. 11(a1) to 11(a3) and FIGS. 11(b1) to 11(b3) show the brightness at the center of the virtual image display region (i.e., the value shown at the center of the table in the upper part) and the distribution of the brightness.

FIGS. 11(a1) and 11(b1) show the cases where an eye of a viewer is at the position of X=23 mm away from the edge surface of the light guide plate (x=8 mm in the prism reflection array region). FIGS. 11(a2) and 11(b2) show the cases where an eye of a viewer is at the position of X=28 mm (x=13 mm). FIGS. 11(a3) and 11(b3) show the cases where an eye of a viewer is at the position of X=33 mm (x=18 mm). FIGS. 11(a2) and 11(b2) show the cases where the position of an eye of a viewer is at the center of the prism reflection array region. FIGS. 11(a1) and 11(b1) show the cases where the position of an eye of a viewer is deviated to the left side. FIGS. 11(a3) and 11(b3) show the cases where the position of an eye of a viewer is deviated to the right side.

In the virtual image display device of Example 1, when the position of an eye of a viewer is at the center of the prism reflection array region, the distribution of the brightness in the virtual image is 75% as shown in FIG. 11(a2). Here, the brightness at the center of the virtual image is assumed as being 1 (standard brightness). When the position of the eye horizontally shifts, the distribution of the brightness in the virtual image varies from 79% to 65% and the brightness at the center of the virtual image varies by about 15% as shown in FIGS. 11(a1) and 11(a3). Note that the above-described distribution of the brightness in the virtual image is defined by the minimum value of the brightness (min)/the maximum value of the brightness (max). As the variation of the brightness decreases, the distribution has a value closer to 100% (=1).

On the other hand, the virtual image display device of Comparative Example 1 has the same configuration as that of Example 1 except for the prism reflection array. In Comparative Example 1, in the prism reflection array, the prisms are formed at a constant pitch (prism width a=0.25 mm, parallel surface width b=0.28 mm, prism pitch p=0.53 mm). Also in this case, the number of prisms included in the prism reflection array is 49.

In the virtual image display device of Comparative Example 1, when the position of an eye of a viewer is at the center of the prism reflection array region, the distribution of the brightness in the virtual image is 50% as shown in FIG. 11(b2), and the uniformity is lower than that of Example 1. In this case, the brightness at the center of the virtual image is 0.99, which is generally equal to that of Example 1.

Note that, however, when the position of the eye horizontally shifts, the distribution of the brightness in the virtual image varies from 65% to 46% as shown in FIGS. 11(b1) and 11(b3). Therefore, the degree of the variation in brightness/darkness varies depending on the viewing position or viewing direction of a viewer. Further, in Comparative Example 1, the brightness at the center of the virtual image greatly varies from 1.75 to 0.68 as shown in FIGS. 11(b1) and 11(b3). Therefore, a virtual image is provided in which the brightness becomes nonuniform depending on the viewing position or viewing direction of a viewer.

It can be seen from the above results that the device of Example 1 in which the prism pitch p is smaller as the distance from the coupling structure 32 increases is capable of providing a virtual image of excellent brightness uniformity as compared with the device of Comparative Example 1 in which the prism pitch p is constant.

Hereinafter, variations of the coupling structure 32 provided at the edge of the light guide plate 30 are described with reference to FIGS. 12(a) to 12(d).

In the virtual image display device 100 of Embodiment 1, a triangular prism arranged so as to face the projection lens system 20 is used as the coupling structure 32, although it may be in any other form. For example, as shown in FIG. 12(a), an alternative coupling structure 32a may include a transparent member in the shape of a triangular prism which is provided on the opposite side to the projection lens system 20 (the upper surface side of the light guide 30) and a reflection film provided on the slope of the transparent member.

Still alternatively, as shown in FIG. 12(b), a coupling structure 32b may be used which is realized by dividing the coupling structure 32a shown in FIG. 12(a) such that triangular prisms, each having a slope (reflecting surface), are arranged side by side. Still alternatively, as in a coupling structure 32c shown in FIG. 12(c), a hologram diffraction grating may be used which is provided on the lower surface side of the light guide 30 so as to face the projection lens system 20. Still alternatively, as in a coupling structure 32d shown in FIG. 12(d), a hologram diffraction grating may be used which is provided on the upper surface side of the light guide 30.

### Embodiment 2

FIG. 13(a) is a cross-sectional view showing a virtual image display device 200 of Embodiment 2. The virtual image display device 200 of the present embodiment is different from the virtual image display device 100 of Embodiment 1 in that, as shown in FIGS. 13(b) and 13(c), at a predetermined position on the lower transparent member 301 that is a constituent of the light guide plate 30, a prism array 303 is formed by the 2p process using a different material from that of the lower transparent member 301. In the virtual image display device 200, a dielectric film formed by deposition so as to have a predetermined thickness is used as the semi-reflective film 36. Note that components of the virtual image display device 200 which are equivalent to those of the virtual image display device 100 of Embodiment 1 are denoted by the same reference numerals, and the detailed descriptions thereof are sometimes omitted.

In the virtual image display device 200, the prism array 303 on the surface of the lower transparent member 301 is formed by the 2p process using a different material from that of the lower transparent member 301 (UV-curable resin). The lower transparent member 301 may be a transparent member, such as a glass plate.

The 2p process refers to, for example, a molding method which includes the following steps. Firstly, a UV-curable resin material is applied to a stamper which has a die at the surface. Thereafter, a transparent substrate is pressed against the applied UV-curable resin material such that the transparent substrate and the resin are bound together. Thereafter, the resin is irradiated with ultraviolet light via the transparent substrate so as to be cured, before carrying out a mold releasing process. Thereby, the resultant transparent substrate has a transparent resin layer to which the shape of the die is transferred.

Thus, according to the 2p process, a structure is obtained in which the prism array 303 formed of the UV-curable resin is provided on the transparent substrate (lower transparent member 301). Note that the prism array 303 may have the same configuration as that of Embodiment 1. That is, the prism array 303 may have such an arrangement pattern that each of the prisms 34A has the first slope surface S341 and the second slope surface S342 and the parallel surface S35 extending between the prisms have a greater width at a position closer to the coupling structure 32.

The semi-reflective film 36 is formed by oblique evaporation, or the like, so as to selectively cover the first slope surface S341 of the prisms 34A and the parallel surface S35 as in Embodiment 1. Note that, however, in the present embodiment, a dielectric film is used rather than a metal film. When a dielectric film is used, the dielectric film does not absorb light, while a metal film would absorb light, so that light can be reflected with higher efficiency. Thus, a brighter virtual image can be displayed.

As the material of the planarizing layer 38 that covers the prism reflection array 34, the same UV-curable resin as that used for formation of the prism array 303 can be used. When the prism array 303 and the planarizing layer 38 are made of the same material, these components have the same refractive index. Since when the same material is used these components have identical refractive indices and hence identical wavelength dispersions, occurrence of blurring and ghosts can be suppressed in both the virtual image and the external scene.

Note that each of the prisms that form the prism array is not limited to the illustrated raised shape projecting from the parallel surface S35 to the planarizing layer 38 but may have a recessed prism shape. Also in this case, the recessed prism shape can be formed by the 2p process using a UV-curable resin. In the section of Embodiment 4 which will be described later, a prism reflection array which has such a recessed prism shape will be described.

Hereinafter, a more specific example (Example 2) of the virtual image display device 200 of Embodiment 2 is described.

In Example 2, a glass substrate was used as the lower transparent member 301, and a prism array 303 was formed on the lower transparent member 301 by the 2p process. The transparent material used for formation of the prism array 303 was a UV-curable resin “NT-32UV” manufactured by Nitto Denko Corporation. The 2p process includes applying the UV-curable resin to a die which has recessed and raised portions corresponding to the prism array at the surface, placing a glass substrate and compressing the UV-curable resin into gaps, irradiating the resin with ultraviolet light such that the resin is cured by polymerization, and thereafter, releasing the cured resin from the die. Through this process, the shape of the die can be transferred.

The planar size of the light guide plate 30 was X=45 mm, Y=30 mm. The shape of the prism was α=26°, β=85°. The prism array was provided in a region having the width of x=26 mm, from the position of 15 mm to the position of 41 mm along the X direction, relative to the edge surface at which the coupling structure 32 was provided.

The prism width a was 0.25 mm (a=0.25 mm). The parallel surface width b was gradually decreased from 0.55 mm to 0 mm along the X direction, from the side which is close to the coupling structure 32 to the side which is distant from the coupling structure 32. Therefore, the prism pitch p varies from 0.8 mm to 0.25 mm, but even the maximum prism pitch p (a region nearest to the coupling structure 32) is smaller than the minimum pupil diameter, 2 mm. In this case, the number of prisms included in the prism reflection array is 60. Note that, as the lower transparent member 301 (transparent substrate), a substrate which is made of a transparent resin, such as typically acrylic and polycarbonate resins, can alternatively be used.

As the semi-reflective film 36, TiO₂ was deposited via a mask by oblique evaporation to a predetermined thickness (about 65 nm) in a rectangular region having a width of x=26 mm in the X direction and a width of y=18 mm in the Y direction.

The material used for the planarizing layer 38 was a UV-curable resin “NT-32UV” manufactured by Nitto Denko Corporation, as was used for the prism array 303. The UV-curable resin was applied to the prism array 303, on which a semi-reflective film has been provided, and compressed into gaps. The resin was irradiated with ultraviolet light such that the resin was cured by polymerization, whereby the planarizing layer 38 was formed. The total thickness of the light guide plate 30 was t=2.2 mm.

Note that the coupling structure 32 was formed of glass separately from the light guide plate 30 and then adhered to the light guide plate 30. In the coupling structure 32, the slope angle γ of the light receiving surface was γ=52°, and the width c of the light receiving surface was c=6 mm.

The thus-produced light guide plate was combined with a virtual image projector to construct a see-through type virtual image display device (head mount display). Note that the angle of view of virtual images projected by the virtual image projector was ±9.8° in the horizontal direction (the traveling direction of virtual image projecting light in the light guide plate: X direction) and ±5.5° in the vertical direction (Y direction).

FIG. 14(a) is a graph illustrating the prism pitch p and the parallel surface width b corresponding to the prism arrangement positions in the virtual image display device of Example 2. FIG. 14(b) is a graph illustrating the angle dependence of the incidence angle (or reflection angle) as for the transmittance and reflectance of a semi-reflective film (TiO₂ film).

As seen from FIG. 14(a), in the prism reflection array, the prism pitch p and the parallel surface width b are large on the side which is close to the light receiving section 30B, while the prism pitch p and the parallel surface width b are small on the side which is distant from the light receiving section 30B. As seen from FIG. 14(b), in the virtual image display device of Example 2, light which is incident generally vertically at the incidence angle of 0° has high transmittance but low reflectance. Light which is incident generally horizontally at the incidence angle of 90° has low transmittance but high reflectance. Note that, in Example 2, a TiO₂ film is used as the semi-reflective film, and therefore, light is not absorbed by the semi-reflective film.

Next, how the outgoing light intensity varied in a plane in the case where the prism reflection array was configured as in Example 2 (FIGS. 15(a1) to 15(a3)) and the case where the prism pitch p and the parallel surface width b of the prism reflection array were constant as in Comparative Example 2 (FIGS. 15(b1) to 15(b3)) is described with reference to FIG. 15.

The display region of a virtual image was divided by five in the X direction and by three in the Y direction. The upper parts of FIGS. 15(a1) to 15(a3) and FIGS. 15(b1) to 15(b3) (5×3 tables) show the relative brightness of the virtual image at the central part of each of the divisional regions. The numbers shown in respective tables are relative values (a.u.) with respect to the brightness at the center of the virtual image while an eye of a viewer is positioned at the center of the prism reflection array in above-described Example 1 (FIG. 11(a2)), which is assumed as being 1 (standard brightness). The lower parts of FIGS. 15(a1) to 15(a3) and FIGS. 15(b1) to 15(b3) show the brightness at the center of the virtual image display region (i.e., the value shown at the center of the table in the upper part) and the distribution of the brightness.

FIGS. 15(a1) and 15(b1) show the cases where an eye of a viewer is at the position of X=23 mm away from the edge surface of the light guide plate (x=8 mm in the prism reflection array region). FIGS. 15(a2) and 15(b2) show the cases where an eye of a viewer is at the position of X=28 mm (x=13 mm). FIGS. 15(a3) and 15(b3) show the cases where an eye of a viewer is at the position of X=33 mm (x=18 mm). FIGS. 15(a2) and 15(b2) show the cases where the position of an eye of a viewer is at the center of the prism reflection array region. FIGS. 15(a1) and 15(b1) show the cases where the position of an eye of a viewer is deviated to the left side. FIGS. 15(a3) and 15(b3) show the cases where the position of an eye of a viewer is deviated to the right side.

In the virtual image display device of Example 2, when the position of an eye of a viewer is at the center of the prism reflection array region, the distribution of the brightness in the virtual image is 78% as shown in FIG. 15(a2). Here, the brightness at the center of the virtual image is 1.3. That is, the brightness at the center of the virtual image improved 30% as compared with a case where the metal reflection film of Example 1 is used. Even when the position of the eye horizontally shifts, the distribution of the brightness in the virtual image and the brightness at the center are generally constant as shown in FIGS. 15(a1) and 15(a3).

On the other hand, the virtual image display device of Comparative Example 2 has the same configuration as that of Example 2 except for the prism reflection array. In Comparative Example 2, in the prism reflection array, the prisms were formed at a constant pitch (prism width a=0.25 mm, parallel surface width b=0.18 mm, pitch p=0.43 mm). Also in this case, the number of prisms included in the prism reflection array was 60.

In the virtual image display device of Comparative Example 2, when the position of an eye of a viewer is at the center of the prism reflection array region, the distribution of the brightness in the virtual image is 62% as shown in FIG. 15(b2), and the uniformity is lower than that of Example 2. In this case, the brightness at the center of the virtual image is 1.38, which is generally equal to that of Example 2.

Note that, however, when the position of the eye horizontally shifts, the distribution of the brightness in the virtual image varies from 65% to 48% as shown in FIGS. 15(b1) and 15(b3), and the uniformity is lower than that of Example 2. Therefore, the degree of the variation in brightness/darkness varies depending on the viewing position or viewing direction of a viewer. Further, in Comparative Example 2, the brightness at the center of the virtual image greatly varies from 2.02 to 1.02 as shown in FIGS. 15(b1) and 15(b3). Therefore, a virtual image is provided in which the brightness becomes nonuniform depending on the viewing position or viewing direction of a viewer.

Although the virtual image display device 200 of Embodiment 2 has been described in the foregoing, the coupling structure 32 may be selected from various forms such as those described with reference to FIGS. 12(a) to 12(d) as in Embodiment 1.

### Embodiment 3

FIG. 16(a) is a cross-sectional view showing a virtual image display device 300 of Embodiment 3. A major difference of the virtual image display device 300 of the present embodiment from the virtual image display device 200 of Embodiment 2 resides in that the prism array is also provided outside the region in which the prism reflection array 34 is provided as shown in FIGS. 16(b) and 16(d). Note that, however, the prism array provided in the outside regions is not provided with a semi-reflective film so that light is not reflected by a prism surface.

Also in the light guide plate 30 of the virtual image display device 300, a prism reflection array is formed by the 2p process as in Embodiment 2. More specifically, a lower transparent member (e.g., glass substrate) 301 on which a prism array 303 has been formed of a UV-curable resin by the 2p process is produced. A semi-reflective film 36 is provided on this prism array, and thereafter, the uneven surface is filled with a planarizing layer 38, whereby a light guide plate 30 is obtained. As the UV-curable resin for formation of the prism array 303, for example, a UV-curable resin “NT-32UV” manufactured by Nitto Denko Corporation can be used. The semi-reflective film 36 is realized by selectively depositing a TiO₂ film to a thickness of about 65 nm on the first slope surface S341 of the prisms and the parallel surface S35 extending between the prisms.

As the second transparent material for formation of the planarizing layer 38, the second transparent material used for formation of the prism array 303 (“NT-32UV” manufactured by Nitto Denko Corporation) can be used. When the first transparent material is the same as the second transparent material, refraction at the interface can be prevented irrespective of the wavelength of incident light.

In the present embodiment, in the step of forming the prism array using the above-described 2p process, a prism array 303′ is also provided in regions other than the region in which the prism reflection array 34 is provided. More specifically, a prism array may be provided over generally the entire surface of the UV-curable resin using a stamper which has recessed and raised portions corresponding to the prism array over generally the entire surface. The method for producing the lower transparent member that has a prism array over the entire surface is not limited to the above-described 2p process. For example, the lower transparent member can be produced by injection molding using an appropriate mold.

The semi-reflective film 36 only needs to be formed in a region in which the prism reflection array 34 is to be provided using a mask M such as shown in FIG. 8(b). Thus, as shown in FIGS. 16(b) and 16(d), the prism array 303′ that does not have the semi-reflective film 36 is provided in regions outside the prism reflection array 34.

FIG. 17 is a cross-sectional view illustrating a case where the prism array 303′ is provided in regions outside the prism reflection array 34 (“WITH SUPPORTING MEMBER” in the upper part of the drawing) and a case where the prism array 303′ is not provided in regions outside the prism reflection array 34 (“WITHOUT SUPPORTING MEMBER” in the lower part of the drawing).

As illustrated in the upper part of FIG. 17, the prism array 303′ is also provided in regions other than the region in which the prism reflection array 34 is provided. In this case, the prism array 303′ provided in these regions serves as a transparent supporting member for supporting the planarizing layer 38. As a result, the planarizing layer 38 can be formed with a high degree of flatness.

On the other hand, in the case where the prism array 303′ is not provided in a region outside the prism reflection array 34 as illustrated in the lower part of FIG. 17, deformation or undulation occurs in the surface in the step of forming the planarizing layer 38 due to shrinkage of the transparent material through the curing process and affects the display quality of virtual images. Also, it affects the quality in appearance of the light guide plate 30.

Note that, even when the prism array 303′ that serves as the transparent supporting member is provided outside the prism reflection array 34 as shown in FIG. 18, light is not reflected or refracted by the surface of the prism array 303′ so long as the prism array 303′ has an equal refractive index to that of the overlying planarizing layer 38. Accordingly, likewise as in the other embodiments, light L1 from the display element 10 travels through the inside of the light guide plate 30 toward the prism reflection array 34 while undergoing total reflection at the reflection angle 2α. Therefore, in the prism reflection array 34, light can outgo appropriately in the normal direction of the exit surface.

### Embodiment 4

FIG. 19(a) is a cross-sectional view showing a virtual image display device 400 of Embodiment 4. A major difference of the virtual image display device 400 of the present embodiment from the virtual image display device 200 of Embodiment 2 resides in that, as shown in FIG. 19(c), in the prism reflection array 34, a prism array including recessed prisms 34B is provided on a lower transparent member (transparent substrate) 301. In the prism array including the recessed prisms 34B, flat portions (parallel surface S35) extending between the prisms 34B are present at a higher level than the first slope surface S341 and the second slope surface S342, i.e., present on a side closer to a major surface S31 that is opposite to another major surface on which the light exit surface S30 of the light guide plate 30 is provided.

Such a prism array is provided in a relatively thick transparent member 304. Therefore, as shown in FIGS. 19(b) and 19(d), a thickness portion 304′ of the transparent member 304 serves as a transparent supporting member. The thickness t2 of the transparent member 304 depends on the size (height) of the prisms 34B. The surface of the thickness portion 304′ of the transparent member 304 is desirably in the same plane as the parallel surface S35.

In the light guide plate 30 of the virtual image display device 400, the prism reflection array 34 is formed by the 2p process. More specifically, a prism array (transparent member 304) including the recessed prisms 34B is formed on the transparent substrate (e.g., glass substrate) 301 by the 2p process. A semi-reflective film 36 is formed on this prism array, and thereafter, an uneven surface is filled with a planarizing layer 38, whereby a light guide plate 30 is obtained. Note that, as the UV-curable resin for formation of the prism array, for example, a UV-curable resin “NT-32UV” manufactured by Nitto Denko Corporation can be used. The semi-reflective film 36 is realized by selectively depositing a TiO₂ film to a thickness of about 65 nm on the first slope surface of the prisms and the parallel surface extending between the prisms. When the same transparent material as that used for the prism array (“NT-32UV” manufactured by Nitto Denko Corporation) is used as the transparent material for formation of the planarizing layer 38, refraction at the interface can be prevented irrespective of the wavelength of incident light.

In the thus-produced light guide plate 30, the thickness portion 304′ of the transparent member 304 is present in a region outside the region in which the prism reflection array 34 is provided, and this serves as the supporting member. Therefore, likewise as in the case of Embodiment 3 illustrated in FIG. 17, the upper surface of the planarizing layer 38 can be a flat surface.

The surface of the thickness portion 304′ of the transparent member 304 is flat, and the interface between the surface of the thickness portion 304′ and the overlying planarizing layer 38 is also flat. In this case, the semi-reflective layer 36 may be provided in a region outside the prism reflection array 34, unlike the configuration shown in FIGS. 19(b) and 19(d). Even when the semi-reflective film 36 is provided in the thickness portion 304′, light traveling through the inside of the light guide plate is not reflected at an undesired angle, so that the semi-reflective film 36 would not impede the traveling of the light. In such a configuration, at the step of forming the semi-reflective film 36, the mask M such as shown in FIG. 8 may not be provided, and the semi-reflective film 36 may be deposited over the entire surface. In this way, the manufacturing process can be simplified.

In the foregoing, the virtual image display devices of Embodiments 1 to 4 have been described, while various modifications are possible. For example, the light exit surface S30 of the light guide plate 30 is not necessarily a flat surface but may be, for example, a curved recessed surface (spherical or hemispherical surface).

This specification discloses lightguides and virtual image display devices described in the following items.

[Item 1]

A lightguide, including:

a coupling structure having a light receiving surface receiving light from a display element; and

a light guide plate having a light receiving section at which light from the coupling structure enters, the light guide plate including a plurality of reflecting structures arranged so as to reflect light entering from the light receiving section and traveling through an inside of the light guide plate mainly in a first direction, the light guide plate being configured such that the light reflected by the plurality of reflecting structures outgoes from an exit surface,

wherein each of the plurality of reflecting structures has a reflecting surface which is oblique to the exit surface, and

when seen in a normal direction of the exit surface, the area ratio per unit area of the oblique reflecting surface in the first direction varies depending on a distance from the light receiving section.

According to the lightguide of Item 1, unevenness in brightness of a virtual image to be viewed is suppressed.

[Item 2]

The lightguide as set forth in Item 1, wherein the area ratio of the oblique reflecting surface in a region where the distance from the light receiving section is smaller is smaller than the area ratio of the oblique reflecting surface in a region where the distance from the light receiving section is greater.

According to the lightguide of Item 2, unevenness in brightness of a virtual image to be viewed is effectively suppressed.

[Item 3]

The lightguide as set forth in Item 1 or 2, wherein the following formula is met:

c(cos(γ)+sin(γ)tan(2α))≧2t·tan(2α),

where α is the angle between the reflecting surface and the exit surface, γ is the angle between the light receiving surface of the coupling structure and the exit surface, c is a width of the light receiving surface of the coupling structure which is defined in a direction perpendicular to the intersection of the light receiving surface and the exit surface, and t is the thickness of the light guide plate.

According to the lightguide of Item 3, unevenness in brightness of a virtual image to be viewed is effectively suppressed.

[Item 4]

The lightguide as set forth in any of Items 1 to 3, wherein each of the plurality of reflecting structures has a prism structure, the reflecting surface is provided at one face of the prism structure, and when seen in a normal direction of the exit surface, a presence ratio per unit area of the prism structure increases as the distance from the light receiving section increases along the first direction.

According to the lightguide of Item 4, unevenness in brightness of a virtual image to be viewed is effectively suppressed.

[Item 5]

The lightguide as set forth in Item 4, wherein in an array of the plurality of prism structures included in the plurality of reflecting structures, a parallel surface which is generally parallel to the exit surface is provided between adjoining prism structures, a width of the parallel surface is greater at a first position that is closer to the light receiving section and is smaller at a second position that is more distant from the light receiving section.

According to the lightguide of Item 5, unevenness in brightness of a virtual image to be viewed is effectively suppressed.

[Item 6]

The lightguide as set forth in Item 5, wherein at a third position that is more distant from the light receiving section than the second position is, the parallel surface is not provided between the prism structures, and adjoining prism structures are in contact with each other.

According to the lightguide of Item 6, unevenness in brightness of a virtual image to be viewed is effectively suppressed.

[Item 7]

The lightguide as set forth in Item 5 or 6, wherein the parallel surface also has a reflecting surface.

According to the lightguide of Item 7, unevenness in brightness of a virtual image to be viewed is effectively suppressed, and the reflectance of the light guide plate can be uniform across the surface of the light guide plate.

[Item 8]

The lightguide as set forth in any of Items 4 to 7, further including a planarizing layer, the planarizing layer being in contact with the plurality of prism structures, the planarizing layer being arranged so as to cover the plurality of prism structures, and the planarizing layer having a substantially flat surface.

According to the lightguide of Item 8, scattering of light at the surface is prevented, and the appearance is better.

[Item 9]

The lightguide as set forth in Item 8, wherein the plurality of prism structures are formed of a first transparent material by a 2p process, and the planarizing layer is also formed of the first transparent material.

According to the lightguide of Item 9, refraction of light at the interface between the prism structure and the planarizing layer can be suppressed.

[Item 10]

The lightguide as set forth in any of Items 4 to 9, wherein outside a region in which a prism structure having the reflecting surface is provided, a prism structure having no reflecting surface is provided.

According to the lightguide of Item 10, the degree of flatness of the surface of the light guide plate can be improved.

[Item 11]

The lightguide as set forth in any of Items 4 to 9, wherein outside a region in which a prism structure having the reflecting surface is provided, a supporting structure which has the same height as the prism structure is provided.

According to the lightguide of Item 11, the degree of flatness of the surface of the light guide plate can be improved.

[Item 12]

The lightguide as set forth in any of Items 1 to 11, wherein the reflecting surface is a semi-reflective surface which is configured to reflect part of light traveling through the inside of the light guide and transmit another part of the light.

According to the lightguide of Item 12, an external scene can be viewed, and an image formed by a display device can be displayed as a virtual image.

[Item 13]

A virtual image display device, including the lightguide as set forth in any of Items 1 to 12 and the display element,

wherein the coupling structure of the lightguide receives virtual image projecting light from the display element.

According to the virtual image display device of Item 13, unevenness in brightness of a virtual image to be viewed is suppressed.

[Item 14]

The virtual image display device as set forth in Item 13, wherein the following formula is met:

c(cos(γ)+sin(γ)tan(2α−θo′))≧2t·tan(2α+θo′),

where α is the angle between the reflecting surface and the exit surface, γ is the angle between the light receiving surface of the coupling structure and the exit surface, c is a width of the light receiving surface of the coupling structure which is defined in a direction perpendicular to the intersection of the light receiving surface and the exit surface, t is the thickness of the light guide plate, ±θo is the angle of view in the first direction of the virtual image projecting light outgoing from the exit surface, and θo′ is the refraction angle at the light guide plate of light outgoing at the angle of view ±θo.

According to the virtual image display device of Item 14, unevenness in brightness of a virtual image to be viewed is effectively suppressed.

### INDUSTRIAL APPLICABILITY

A lightguide of the present invention is applicable to a virtual image display device, such as HMD, HUD, or the like.

### REFERENCE SIGNS LIST

10 display element
20 projection lens system
30 light guide plate
30B light receiving section
32 coupling structure
34 prism reflection array
34A prism
36 semi-reflective film
38 planarizing layer
S30 exit surface
S341 first slope surface
S342 second slope surface
S35 parallel surface
100, 200, 300, 400 virtual image display device

1. A lightguide, comprising:
a coupling structure having a light receiving surface receiving light from a display element; and
a light guide plate having a light receiving section at which light from the coupling structure enters, the light guide plate including a plurality of reflecting structures arranged so as to reflect light entering from the light receiving section and traveling through an inside of the light guide plate mainly in a first direction, the light guide plate being configured such that the light reflected by the plurality of reflecting structures outgoes from an exit surface,
wherein each of the plurality of reflecting structures has a reflecting surface which is oblique to the exit surface, and
when seen in a normal direction of the exit surface, the area ratio per unit area of the oblique reflecting surface in the first direction varies depending on a distance from the light receiving section.

2. The lightguide of claim 1, wherein the area ratio of the oblique reflecting surface in a region where the distance from the light receiving section is smaller is smaller than the area ratio of the oblique reflecting surface in a region where the distance from the light receiving section is greater.

3. The lightguide of claim 1, wherein
each of the plurality of reflecting structures has a prism structure,
the reflecting surface is provided at one face of the prism structure, and
when seen in a normal direction of the exit surface, a presence ratio per unit area of the prism structure increases as the distance from the light receiving section increases along the first direction.

4. The lightguide of claim 3, wherein in an array of the plurality of prism structures included in the plurality of reflecting structures, a parallel surface which is generally parallel to the exit surface is provided between adjoining prism structures, a width of the parallel surface is greater at a first position that is closer to the light receiving section and is smaller at a second position that is more distant from the light receiving section.

5. The lightguide of claim 4, wherein at a third position that is more distant from the light receiving section than the second position is, the parallel surface is not provided between the prism structures, and adjoining prism structures are in contact with each other.

6. The lightguide of claim 4, wherein the parallel surface also has a reflecting surface.

7. The lightguide of claim 3, further comprising a planarizing layer, the planarizing layer being in contact with the plurality of prism structures, the planarizing layer being arranged so as to cover the plurality of prism structures, and the planarizing layer having a substantially flat surface.

8. The lightguide of claim 7, wherein
the plurality of prism structures are formed of a first transparent material by a 2p process, and
the planarizing layer is also formed of the first transparent material.

9. A virtual image display device, comprising the lightguide as set forth in claim 1 and the display element,
wherein the coupling structure of the lightguide receives virtual image projecting light from the display element.

10. The lightguide of claim 1, wherein the following formula is met:
c(cos(γ)+sin(γ)tan(2α))≧2t·tan(2α),
where α is the angle between the reflecting surface and the exit surface, γ is the angle between the light receiving surface of the coupling structure and the exit surface, c is a width of the light receiving surface of the coupling structure which is defined in a direction perpendicular to the intersection of the light receiving surface and the exit surface, and t is the thickness of the light guide plate.

11. The lightguide of claim 3, wherein outside a region in which a prism structure having the reflecting surface is provided, a prism structure having no reflecting surface is provided.

12. The lightguide of claim 3, wherein outside a region in which a prism structure having the reflecting surface is provided, a supporting structure which has the same height as the prism structure is provided.

13. The lightguide of claim 1, wherein the reflecting surface is a semi-reflective surface which is configured to reflect part of light traveling through the inside of the light guide and transmit another part of the light.

14. The virtual image display device of claim 9, wherein the following formula is met:
c(cos(γ)+sin(γ)tan(2α−θo′))≧2t·tan(2α+θo′),
where α is the angle between the reflecting surface and the exit surface, γ is the angle between the light receiving surface of the coupling structure and the exit surface, c is a width of the light receiving surface of the coupling structure which is defined in a direction perpendicular to the intersection of the light receiving surface and the exit surface, t is the thickness of the light guide plate, ±θo is the angle of view in the first direction of the virtual image projecting light outgoing from the exit surface, and θo′ is the refraction angle at the light guide plate of light outgoing at the angle of view ±θo.
